(19) United States
(12) Patent Application Publication
(10) Pub. No.: US 2026/0230140 A1
(43) Pub. Date: Aug. 6, 2026

(54) CODE BOOK SUBSET RESTRICTION FOR CJT OVER MULTIPLE TRPs

(71) Applicant: TELEFONAKTIEBOLAGET LM ERICSSON (PUBL), Stockholm (SE)

(72) Inventors: Shiwei Gao, Nepean, Ontario (CA); Siva Muruganathan, Stittsville, Ontario (CA); Xinlin Zhang, Västra Frölunda (SE)

(21) Appl. No.: 19/147,782

(22) PCT Filed: Jan. 16, 2024
(86) PCT No.: PCT/IB2024/050412

§ 371 Date: Jul. 14, 2025

Related U.S. Application Data
(60) Provisional application No. 63/480,202, filed on Jan. 17, 2023.

(51) Int. Cl. H04B 7/06

(52) U.S. Cl. CPC H04B 7/0626; H04B 7/06952

(57) ABSTRACT

Systems and methods are disclosed that relate to codebook subset restriction (CBSR) for Coherent Joint Transmission (CJT) over multiple Transmission and Reception Points (TRPs). In one embodiment, a method performed by a User Equipment (UE) comprises receiving, from a network node, configuration information that configures the UE with Non-Zero Power (NZP) Channel State Information Reference Signal (CSI-RS) resources, each with 2N₁N₂ CSI-RS antenna ports, for CJT Channel State Information (CSI) feedback, wherein N₁ and N₂ are positive integers. The method further comprises receiving, from the network node, CBSR information for one or more of the NZP CSI-RS resources that configures the UE with amplitude restrictions for a subset of spatial vectors or beams on a per NZP CSI-RS resource basis. The method further comprises, reporting, to the network node, CSI based on the configuration information and the CBSR information.

### RELATED APPLICATIONS

This application claims the benefit of provisional patent application Ser. No. 63/480,202, filed Jan. 17, 2023, the disclosure of which is hereby incorporated herein by reference in its entirety.

### TECHNICAL FIELD

The present disclosure relates to downlink Coherent Joint Transmission (CJT) over multiple Transmission and Reception Points (TRPs) in a wireless network and, more specifically, to codebook subset restriction for downlink CJT over multiple TRPs in a wireless network.

### BACKGROUND

### Codebook-Based Precoding

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

A core component of the fourth and fifth Generation (4G/5G) wireless network or New Radio (NR) specified in 3^{rd} Generation Partnership Project (3GPP) is the support of MIMO antenna deployments and MIMO related techniques such as spatial multiplexing. Spatial multiplexing can be used to increase data rates in favorable channel conditions. FIG. 1 shows an example of spatial multiplexing, where an information carrying symbol vector s is multiplied by an N_{T}×r (rows×columns) precoding matrix or precoder W, which serves to distribute the transmit energy on the N_{T} transmit antenna ports in r “virtual” spatial directions, each associated to a data stream, such that they can be distinguished at the User Equipment (UE). The precoding matrix is typically selected from a codebook of possible precoding matrices, and typically reported by a UE in the form of a Precoding Matrix Indicator (PMI). PMI indicates a desired precoding matrix in the codebook for a given number of symbol streams. Vector s contains r symbols each corresponding to a MIMO layer or data stream, and r is referred to as the transmission rank or simply rank. In this way, spatial multiplexing is achieved since multiple symbols or data streams can be transmitted simultaneously over the same time/frequency Resource Elements (REs). r is selected to suit the matrix channel H and is typically reported by a UE in the form of a Rank Indicator (RI).

NR uses Orthogonal Division Multiplexing (OFDM) in downlink. The received N_{R}×1 vector y at a UE in a scheduled RE can be expressed as

$$y = HWx + e$$

where e is a receiver noise/interference vector.

The precoder W is chosen to match the characteristics of the N_{R}×N_{T} MIMO channel matrix H. This is also commonly referred to as closed-loop precoding. In closed-loop precoding, the UE feeds back recommendations on a suitable precoder to the NR base station, which is referred to as a gNodeB (gNB), in the form of a PMI based on downlink channel measurements. For that purpose, the UE is configured with a Channel State Information (CSI) report configuration including CSI Reference Signals (CSI-RS) for channel measurements and a codebook of candidate precoders. In addition to PMI and RI, the feedback typically also includes a Channel Quality Indicator (CQI). RI, PMI, and CQI are part of a CSI feedback. In NR, PMI and CQI feedback can be either per wideband or per subband where a subband is defined as a number of contiguous Physical Resource Blocks (PRBs) ranging between 4-32 PRBs depending on the Bandwidth Part (BWP) size.

The transmit antennas at the gNB can be a linear antenna array with uniformly spaced antenna ports or a two-dimensional antenna array with uniformly spaced antenna ports in each dimension. The antenna array can be described by a number of antenna ports, N₁, in a first dimension (e.g., the horizontal dimension), a number of antenna ports, N₂, in the second dimension perpendicular to the first dimension (e.g., the vertical dimension), and a number of polarizations Nₚ. The total number of antenna ports is thus N_{T}=N₁N₂Nₚ. The concept of an antenna port is non-limiting in the sense that it can refer to any virtualization (e.g., linear mapping) to one or multiple physical antenna elements. For example, pairs of physical antenna elements could be fed the same signal, and hence share the same virtualized antenna port.

An example of a 4×4 (i.e., N₁×N₂) array with dual-polarized antenna elements (i.e., Nₚ=2) is illustrated below in FIG. 2. In other words, FIG. 2 illustrates an example of a two-dimensional antenna array of dual-polarized antenna elements (Nₚ=2), with N₁=4 horizontal antenna elements and N₂=4 vertical antenna elements.

Precoding may also be interpreted as beamforming where the signal to be transmitted on the antenna ports are multiplied by a set of beamforming weights prior to transmission. The beamforming weights are specified by the precoding matrix. Each MIMO layer is transmitted on an antenna beam.

### DFT-Based Precoders

A common type of precoder is a Discrete Fourier Transform (DFT) based precoder, where the precoding vector for each MIMO layer is a DFT vector, i.e., each column of W is a DFT vector. For a single-polarized Uniform Linear Array (ULA) with N antennas, a DFT based precoder is defined as

$${w}_{1 D} ( k ) = {u}_{k} = \frac{1}{\sqrt{N}} [ \begin{matrix}{e}^{j 2 π \cdot 0 \cdot \frac{k}{O N}} \\ {e}^{j 2 π \cdot 1 \cdot \frac{k}{O N}} \\ ⋮ \\ {e}^{j 2 π \cdot ( N - 1 ) \cdot \frac{k}{O N}}\end{matrix} ] ,$$

where k=0, 1, . . . ON−1 is the precoder index and O is an integer oversampling factor. uₖ is also referred to as a one-dimensional (1-D) DFT beam with beam index k. If ULA is along the horizontal dimension, each DFT beam points to an azimuth direction. If ULA is along the vertical dimension, each DFT beam points to an elevation direction.

For a two-dimensional Uniform Planar Array (UPA) with N₁ antenna ports in one dimension and N₂ antenna ports in another dimension, a DFT based precoder can be similarly created by taking the Kronecker product of two DFT precoder vectors, one in each dimension, as

$${w}_{2 D} ( k , l ) = {v}_{k , l} = {u}_{k , 1} ⊗ {u}_{l , 2} ,$$

where

$${u}_{k , 1} = \frac{1}{\sqrt{{N}_{1}}} [ \begin{matrix}{e}^{j 2 π \cdot 0 \cdot \frac{k}{{O}_{1} {N}_{1}}} \\ {e}^{j 2 π \cdot 1 \cdot \frac{k}{{O}_{1} {N}_{1}}} \\ ⋮ \\ {e}^{j 2 π \cdot ( {N}_{1} - 1 ) \cdot \frac{k}{{O}_{1} {N}_{1}}}\end{matrix} ]$$

$$and$$

$${u}_{l , 2} = \frac{1}{\sqrt{{N}_{2}}} [ \begin{matrix}{e}^{j 2 π \cdot 0 \cdot \frac{l}{{O}_{2} {N}_{2}}} \\ {e}^{j 2 π \cdot 1 \cdot \frac{l}{{O}_{2} {N}_{2}}} \\ ⋮ \\ {e}^{j 2 π \cdot ( {N}_{2} - 1 ) \cdot \frac{l}{{O}_{2} {N}_{2}}}\end{matrix} ]$$

are 1-D DFT beams in each of the two dimensions, and O₁ and O₂ are the over sampling factors in the two dimensions associated with N₁ and N₂, respectively. v_{k,l} is also referred to as a two-dimensional (2-D) DFT beam characterized by two beam indices (k, l), one in each dimension. Each precoder corresponds to a 2-D DFT beam.

Extending the DFT precoder for a dual-polarized UPA can then be done as

$${w}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jφ} is a co-phasing factor that may be selected from M-PSK alphabet such as QPK with

$$ϕ ∈ \{ 0 , \frac{π}{2} , π , \frac{3 π}{2} \} .$$

The above assumes that the same DFT beam is used for both polarizations.

A precoding matrix W_{2D,DP} for multi-layer transmission may be created by appending columns of DFT vectors as

$${W}_{2 D , DP} = [ {W}_{2 D , DP} ( {k}_{1} , {l}_{1} , {ϕ}_{1} ) {w}_{2 D , DP} ( {k}_{2} , {l}_{2} , {ϕ}_{2} ) ⋯ {w}_{2 D , DP} ( {k}_{r} , {l}_{r} , {ϕ}_{r} ) ] ,$$

where r is the number of transmission layers. Such DFT-based precoders are used for instance in NR Type I CSI feedback, where each layer is associated with one 2D DFT beam.

### NR Rel-15 Type II Codebook

To better reflect the multi-path propagation nature of the wireless channel, type II codebooks were introduced in NR Rel-15, in which a precoder for each MIMO layer consists of a combination of multiple DFT beams. The number of DFT beams can be configured by Radio Resource Control (RRC). The precoder is reported as multiple DFT beams selected by the UE and the corresponding combination coefficients. A common set of DFT beams are selected for all layers.

For a given 2D cross-polarized antenna array with N₁ antenna ports in one dimension and N₂ antenna ports in another dimension at each polarization, a precoder layer l∈{1,2} in NR Rel-15 type codebook can be expressed as

$${w}_{l} = {W}_{1} {w}_{2 , l}$$

$$where$$

$$\cdot {W}_{1} = [ \begin{matrix}{v}_{{m}_{1}^{( 0 )} , {m}_{2}^{( 0 )}} , … , {v}_{{m}_{1}^{( L - 1 )} , {m}_{2}^{( L - 1 )}} & 0 \\ 0 & {v}_{{m}_{1}^{( 0 )} , {m}_{2}^{( 0 )}} , … , {v}_{{m}_{1}^{( L - 1 )} , {m}_{2}^{( L - 1 )}}\end{matrix} ] ,$$

$$\{ {v}_{{m}_{1}^{( 0 )} , {m}_{2}^{( 0 )}} , … , {v}_{{m}_{1}^{( L - 1 )} , {m}_{2}^{( L - 1 )}} \}$$

is a set of size P_{CSI-RS}/2×1 2-D DFT beams, P_{CSI-RS}=2N₁N₂,

$${m}_{1}^{( i )} ∈ \{ 0 , 1 , … , {O}_{1} {N}_{1} - 1 ) and {m}_{2}^{( i )} ∈ \{ 0 , 1 , … , {O}_{2} {N}_{2} - 1 )$$

are the beam indices in each dimension for the ith selected DFT beam. L∈{2,3,4} is configured by RRC. W₁ is common to all layers
W_{2,l}=[W_{2,l,0}, W_{2,l,1}> . . . , W_{2,l,2L-1}]^{T}, where

$${w}_{2 , l , i} = {p}_{l , i}^{( 1 )} {p}_{l , i}^{( 2 )} {φ}_{l , i}$$

is the combining coefficient associated with the i^{th} beam, and

$${p}_{l , i}^{( 1 )} , {p}_{l , i}^{( 2 )} ,$$

and φ_{l,i} are the wideband amplitude, subband amplitude, and phase of w_{2,l,i}, respectively.

$${p}_{l , i}^{( 1 )} ∈ \{ 0 , \sqrt[2]{\frac{1}{{2}^{k}}} , k = 0 , 1 , … , 6. \} and {p}_{l , i}^{( 2 )} ∈ \{ 1 , 1 / \sqrt[2]{2} \}$$

wₗ is expressed in section 5.2.2.2.3 of 3GPP Technical Specification (TS) 38.214 V15.16.0 as:

$${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} , {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2$$

where

$${m}_{1}^{( i )} = {O}_{1} {n}_{1}^{( i )} + {q}_{1} , {m}_{2}^{( i )} = {O}_{2} {n}_{2}^{( i )} + {q}_{2} ,$$

q₁∈{0, 1, . . . , O₁−1}, q₂∈{0, 1, . . . , O₂−1},

$${n}_{1} = [ {n}_{1}^{( 0 )} , … , {n}_{1}^{( L - 1 )} ] , {n}_{2} = [ {n}_{2}^{( 0 )} , … , {n}_{2}^{( L - 1 )} ] , {n}_{1}^{( i )} ∈ \{ 0 , 1 , … , {N}_{1} - 1 \} , {n}_{2}^{( i )} ∈ \{ 0 , 1 , … , {N}_{2} - 1 \} ,$$

i=0, 1, . . . , L−1.

$${p}_{l}^{( p )} = [ {p}_{l , 0}^{( p )} … {p}_{l , 2 L - 1}^{( p )} ] , p = 1 , 2 .$$

### NR Rel-16 Enhanced Type II Codebook

The Rel-15 type II codebook is enhanced in NR rel-16 in which, instead of reporting separate precoders for different subbands, the precoders for all subbands are reported together by using a so-called Frequency Domain (FD) basis. It takes advantage of frequency domain channel correlations by representing the precoder changes in frequency domain with a set of frequency domain DFT basis vectors (which will be simply referred to as FD basis vectors). Due to channel correlation in frequency, only a few DFT basis vectors may be used to represent the precoder changes over all the subbands. By doing so, the feedback overhead can be reduced, or performance can be improved for the same feedback overhead.

For each layer l (l=1, . . . , v), a precoder in the Rel-16 type II codebook can be expressed as:

$${W}_{l} = [ {w}_{l}^{( 0 )} {⋯ w}_{l}^{( {N}_{3} - 1 )} ] = {W}_{1} {\tilde{W}}_{2 , l} {W}_{f , l}^{H} ,$$

where:

$${w}_{l}^{( t )} is a {P}_{CSI - RS} \times 1$$

precoding vector at a PMI subband t∈{0, 1, . . . , N₃−1} for layer l, where N₃=N_{SB}×R is the number of subbands for PMI, where N_{SB} is the number of CQI subbands and R∈{1,2} is a scaling factor, both are configured by RRC

W₁ is the same as in Rel-15 type II codebook

$${W}_{f , l} = [ {y}_{l}^{( 0 )} , {y}_{l}^{( 1 )} , … , {y}_{l}^{( {M}_{v} - 1 )} ]$$

is a size N₃×Mᵥ frequency domain (FD) compression matrix for layer l, and comprises Mᵥ FD basis vectors

$$\{ {y}_{l}^{( f )} ,$$

f=0, . . . , Mᵥ−1}, where

$${y}_{l}^{( f )} = {[ {y}_{0 , l}^{( f )} , {y}_{1 , l}^{( f )} , … , {y}_{{N}_{3} - 1 , l}^{( f )} ]}^{T} and {y}_{t , l}^{( f )} = {e}^{- j2π {tn}_{3 , t}^{( f )} / {N}_{3}} ,$$

t=0, 1, . . . , N₃−1, and

$${n}_{3 , l}^{( f )} ∈ \{ 0 , 1 , … , {N}_{3} - 1 \} . {M}_{ν} = ⌈ {p}_{v} \frac{{N}_{3}}{R} ⌉$$

is the number of FD basis vectors, which depends on the RRC configured parameter pᵥ and can be different for different ranks. Supported values of pᵥ can be found in Table 1. Note that

$${y}_{l}^{( 0 )}$$

always corresponds to

$${n}_{3 , l}^{( f )} = 0.$$

For N₃≤19, a one-step free selection is used.
   For each layer, the Mᵥ selected FD basis vectors are indicated with a

$$⌈ {log}_{2} ( \begin{matrix}{N}_{3} - 1 \\ {M}_{v} - 1\end{matrix} ) ⌉$$

bit combinatorial indicator. In 3GPP TS 38.214, the combinatorial indicator is given by the index i_{1,6,l}, which is reported by UE to the gNB.
For N₃>19, a two-step selection with layer-common intermediary subset (IntS) is used.
   In the first step, a window-based layer-common IntS selection is used, which is parameterized by Mᵢₙᵢₜᵢₐₗ. The IntS consists of FD basis vectors {mod (Mᵢₙᵢₜᵢₐₗ+n, N₃), n=0, 1, . . . , 2Mᵥ−1}. In TS 38.214, the selected IntS is reported by the UE to the gNB via the parameter i_{1,5}, which is reported per layer as part of the PMI.
   In the second step, the selected FD basis vectors are indicated with an

$$⌈ {log}_{2} ( \begin{matrix}2 {M}_{v} - 1 \\ {M}_{v} - 1\end{matrix} ) ⌉ - bit$$

combinatorial indicator for each layer. In TS 38.214, the combinatorial indicator is given by the index i_{1,6,l}, which is reported by UE to the gNB.
\tilde{W}_{2,l}=[\tilde{w}_{l,i,f}, i=0, 1, . . . , 2L−1, f=0, 1, . . . , Mᵥ−1] is a size 2L×Mᵥ coefficient matrix for layer l, where only

$${K}_{l}^{N Z} \leq {K}_{0}$$

coefficients are non-zero and reported by the UE. The remaining

$$2 {LM}_{v} - {K}_{l}^{NZ}$$

non-reported coefficients are considered zero.
   K₀=└β×2LM₁┘ is the maximum number of non-zero coefficients per layer, where β is a RRC configured parameter. Supported β values are shown in Table 1.
   For v∈{2,3,4}, the total number of non-zero coefficients reported across all layers,

$${K}_{tot}^{N Z} = {Σ}_{l = 1}^{v} {K}_{l}^{N Z} ,$$

shall satisfy

$${K}_{tot}^{N Z} \leq 2 {K}_{0} .$$

Selected Kₗ^{NZ} non-zero coefficients is indicated by a size 2LMᵥ bitmap, i_{1,7,l}, where each reported non-zero coefficient is indicated with 1.
The strongest coefficient of layer l (whose amplitude and phase are not reported) is identified by i_{1,8,l}∈{0, 1, . . . , 2L−1}.
The amplitude coefficients in W_{2,l} are indicated by i_{2,3,l} (reference amplitude) and i_{2,4,l}, and the phase coefficients in W_{2,l} are indicated by i_{2,5,l}.

The above is described in more detail in 3GPP TS 38.214 (see, e.g., V16.12.0), section 5.2.2.2.5, where

$${w}_{l}^{( t )}$$

is expressed as follows

$${W}_{{q}_{1} , {q}_{2} , {n}_{1} , {n}_{2} , {n}_{3} , l , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$$

$${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$$

where {q₁, q₂, n₁, n₂, n_{3,l},

$${p}_{l}^{( 1 )} , {p}_{l}^{( 2 )}$$

i_{2,5,l}} are quantities reported by a UE and
{q₁, q₂} are reported via the parameter i_{1,1} while {n₁, n₂} are reported via the parameter i_{1,2}.

$${n}_{3 , l} = [ {n}_{3 , l}^{( 0 )} , … , {n}_{3 , l}^{( {M}_{v} - 1 )} ] , {n}_{3 , l}^{( f )} ∈ \{ 0 , 1 , … , {N}_{3} - 1 \} ,$$

are the indices of the Mᵥ FD basis vectors

$$\{ {y}_{l}^{( 0 )} , {y}_{l}^{( 1 )} , … , {y}_{l}^{( {M}_{ν} - 1 )} \}$$

and are reported via parameter i_{1,6,l} and i_{1,5} if N₃>19

$${p}_{l}^{( 1 )} = [ \begin{matrix}{p}_{l , 0}^{( 1 )} & {p}_{l , 1}^{( 1 )}\end{matrix} ]$$

are the reference amplitudes of the coefficients {\tilde{w}_{l,i,f}} at two polarizations, reported by i_{2,3,l}, and

$${p}_{l , i , f}^{( 2 )}$$

is the amplitude of the coefficient \tilde{w}_{l,i,f} with respected to the corresponding reference amplitude, where

$${p}_{l , i , f}^{( 2 )}$$

is part of

$${p}_{l}^{( 2 )} = [ {p}_{l , 0}^{( 2 )} … {p}_{l , {M}_{v} - 1}^{( 2 )} ] , {p}_{l , f}^{( 2 )} = [ {p}_{l , 0 , f}^{( 2 )} … {p}_{l , 2 L - 1 , f}^{( 2 )} ] ,$$

and is reported via i_{2,4,l}.

$${p}_{l , p}^{( 1 )} ∈ \{ \frac{1}{\sqrt[4]{{2}^{k}}} , k = 0 , 1 , … , 15 \} and {p}_{l , i , f}^{( 2 )} ∈ \{ \frac{1}{\sqrt[2]{{2}^{k}}} , k = 0 , 1 , … , 7 \} .$$

$${φ}_{l , i , f} = {e}^{j \frac{2 π {c}_{l , i , f}}{16}}$$

is the phase of coefficient \tilde{w}_{l,i,f}, where c_{l,i,f}∈{0, . . . , 15} is part of i_{2,5,l}=[c_{l,0} . . . c_{1,M}_{ᵥ}₋₁], c_{l,f}=[c_{l,0,f} . . . c_{l,2L-1,f}]

TABLE 1
Codebook parameter configurations for L, β and pᵥ
for Rel-16 enhanced type II codebook

| paramCombination- | | pᵥ | | |
|---|---|---|---|---|
| r16 | L | v ϵ {1, 2} | v ϵ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

### Codebook Subset Restriction (CBSR) for Type II Codebooks

In some deployment scenarios, to reduce potential inter-cell interference, it may be desirable to avoid downlink (DL) transmissions at certain spatial directions such as at or around the horizontal directions. This can be achieved via CBSR in both Rel-15 and Rel-16 type II codebooks, where the spatial beams are divided into 0102 beam groups each comprising N₁N₂ adjacent beams. Beams in four of the O₁O₂ beam groups may be restricted. For each beam in the four of the O₁O₂ beam groups, two bits are used to indicate the amount of amplitude restriction to be applied to the beam. The amount can be 0 (no transmission),

$$\frac{1}{\sqrt[2]{2}} ( half power ) ,$$

$$\frac{1}{\sqrt[2]{4}} ( a quarter of power ) ,$$

or 1 (no restriction, full power) as described in Table 5.2.2.2.3-6 and Table 5.2.2.2.5-6 in 3GPP TS 38.214 v16.12.0 for Rel-15 type II CB and Rel-16 enhanced type II CB, respectively. Table 5.2.2.2.3-6 and Table 5.2.2.2.5-6 are copied below, where

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

are the two bits associated to the beam identified by beam indices {x₁, x₂} in beam group k. For Rel-16 enhanced Type II CB, the average coefficient amplitude for beam i∈(0, 1, . . . , L−1) and polarization p∈(0,1) at layer l∈(1, . . . , v) is defined as

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}}$$

such that

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}} \leq {ℽ}_{i + pL} ,$$

where

$${k}_{l , i + pL , f}^{( 3 )} ∈ \{ 0 , 1 \}$$

is the bitmap as defined in Clause 5.2.2.2.5 of 3GPP TS 38.214.

TABLE 5.2.2.2.3-6
Maximum allowed amplitude coefficients for restricted vectors

| | Maximum |
|---|---|
| | Amplitude |
| Bits | Coefficient |
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | ${p}_{l , i}^{( 1 )}$ |
| 00 | 0 |
| 01 | \sqrt{1/4} |
| 10 | \sqrt{1/2} |
| 11 | 1 |

TABLE 5.2.2.2.5-6
Maximum allowed average coefficient amplitudes for restricted vectors

| | Maximum |
|---|---|
| | Average |
| Bit | Coefficient |
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Amplitude γ_{i+pL} |
| 00 | 0 |
| 01 | \sqrt{1/4} |
| 10 | \sqrt{1/2} |
| 11 | 1 |

If a UE does not report parameter amplitudeSubsetRestriction=‘supported’ or softAmpRestriction-r16=‘supported’ in its capability signaling, the UE is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10. In this case, hard restriction is applied to the beams in the selected beam groups (i.e., either γ_{i+pL}=0 or γ_{i+pL}=1).

An example is illustrated in FIG. 3. In other words, FIG. 3 illustrates an example of CBSR for type II CB with (N₁, N₂)=(2,4) and (O₁, O₂)=(4,4).

Note that in both Rel-15 and Rel-16 type II codebooks, for each layer, a single strongest beam combining coefficient is determined, and its amplitude is set to 1 and is used as the reference for determining or quantization of the amplitudes of other coefficients. Therefore, in case of soft beam restriction, i.e., \sqrt{¼} and \sqrt{½} configured in Table 5.2.2.2.3-6 and Table 5.2.2.2.5-6, the amplitude restriction threshold is effectively with respect to the strongest beam in case Rel-15 type II CBSR and the strongest beam and FD basis vector pair in case of Rel-16 enhanced type II CBSR. This is illustrated in the example shown in FIG. 4, where L=4 beams {a,b,c,d} are selected by the UE and beam d is the strongest beam with its amplitude set to 1 in case of Rel-15 type II codebook or with its reference amplitude set to 1 in case of Rel-16 enhanced type II codebook. Beams a and c are restricted beams configured in CBSR with soft restriction \sqrt{¼} and \sqrt{½}, respectively. In this example, both beams a and c do not exceed the amplitude threshold and are valid. Beams b and d are unrestricted.

### Codebooks for Coherent Joint Transmission Over Multiple TRPs

In NR Rel-18, it has been agreed to support downlink Coherent Joint Transmission (CJT) from multiple Transmission and Reception Points (TRPs) by extending Rel-16 and Rel-17 enhanced type II codebook across multiple TRPs (mTRP for short). In case of CJT, each layer of a Physical Downlink Shared Channel (PDSCH) is transmitted from multiple TRPs. An example is shown in FIG. 5, where two layers of a PDSCH are transmitted from two TRPs by applying two different precoding matrices to the PDSCH at TRP1 and TRP2. The two precoders are designed such that, for each layer, the signals received from the two TRPs are phase aligned at the UE and thus are coherently combined at the UE.

Extension of NR Rel-16 enhanced type II codebook to CJT is currently under discussion in 3GPP RAN1. Two codebook structures or modes have been agreed as follows:
Mode 1: Per-TRP/TRP-group Spatial Domain (SD)/FD basis selection which allows independent FD basis selection across N TRPs/TRP groups. Example formulation (N=number of TRPs or TRP groups):

$$W = [ \begin{matrix}{W}_{1 , 1} & {\tilde{W}}_{2 , 1} & {W}_{f , 1}^{H} \\ & ⋮ & \\ {W}_{1 , N} & {\tilde{W}}_{2 , N} & {W}_{f , N}^{H}\end{matrix} ]$$

Mode 2: Per-TRP/TRP group (port-group or resource) SD basis selection and joint/common (across N TRPs) FD basis selection. Example formulation (N=number of TRPs or TRP groups):

$$W = [ \begin{matrix}{W}_{1 , 1} & {\tilde{W}}_{2 , 1} & {W}_{f}^{H} \\ & ⋮ & \\ {W}_{1 , N} & {\tilde{W}}_{2 , N} & {W}_{f}^{H}\end{matrix} ]$$

In the above formulations, each TRP/TRP group corresponds to one CSI-RS resource.

In both mode 1 and mode 2, the precoding matrix W for CJT is very similar to that in Rel-16 enhanced type II codebook. One difference is that now the spatial beams are selected from multiple TRPs instead of from a single TRP. In Mode 1, FD basis vectors are also selected in a per TRP basis while in Mode 2, a common set of FD basis vectors are selected for all TRPs.

### SUMMARY

Systems and methods are disclosed that relate to codebook subset restriction (CBSR) for Coherent Joint Transmission (CJT) over multiple Transmission and Reception Points (TRPs). In one embodiment, a method performed by a User Equipment (UE) comprises receiving, from a network node, configuration information that configures the UE with a plurality of Non-Zero Power (NZP) Channel State Information Reference Signal (CSI-RS) resources each with 2N₁N₂ CSI-RS antenna ports, for CJT Channel State Information (CSI) feedback, wherein N₁ and N₂ are positive integers. The method further comprises receiving, from the network node, CBSR information for one or more of the plurality of NZP CSI-RS resources that configures the UE with amplitude restrictions for a subset of spatial vectors or beams on a per NZP CSI-RS resource basis. The method further comprises, reporting, to the network node, CSI based on the configuration information and the CBSR information. The CSI comprises information about a number of layers and a subset of the plurality of NZP CSI-RS resources and, for each of the subset of the plurality of NZP CSI-RS resources, information for one or more selected spatial domain (SD) basis vectors or beams. The CSI further comprises, for each of the number of layers, one or more selected frequency domain (FD) basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions. In this manner, flexible configuration of beams to be restricted for different TRPs, e.g., to meet different needs in different deployment scenarios where the antenna heights and orientations may be different, is provided.

In one embodiment, the amplitude restrictions are hard restrictions, wherein a spatial vector or beam is either allowed or prohibited in a CSI report in case of a hard restriction.

In one embodiment, for each beam or spatial vector in the subset of spatial vectors or beams for which amplitude restrictions are configured to the UE for each of the one or more of the plurality of NZP CSI-RS resources, the CBSR information that configures the UE with the amplitude restrictions indicates whether there is no amplitude restriction for the beam or spatial vector or that the beam or spatial vector is prohibited.

In one embodiment, the subset of spatial vectors or beams comprises four beam groups out of O₁O₂ beam groups each comprising N₁N₂ adjacent spatial vectors or beams, wherein O₁=4, and O₂=4 for N₂>1 and O₂=1 for N₂=1. In one embodiment, for each beam or spatial vector in one of the four beam groups configured for codebook subset restriction, the CBSR information that configures the UE with the amplitude restrictions consists of only one bit that indicates whether the beam or spatial vector is prohibited.

In one embodiment, the CBSR information that configures the UE with amplitude restrictions for the subset of beams associated to each of the one or more of the plurality of NZP CSI-RS resources comprises a bit string,

$${B}_{G}^{( n )} {B}_{1}^{( n )} {B}_{2}^{( n )} {B}_{3}^{( n )} {B}_{4}^{( n )} ,$$

for the nth NZP CSI-RS resource, where

$${B}_{G}^{( n )}$$

identifies four beam groups and

$${B}_{k}^{( n )}$$

indicates amplitude restrictions for beams in the kth (k∈(0, 1, 2, 3)) identified beam group. In one embodiment,

$${B}_{k}^{( n )}$$

comprises N₁N₂ bits each associated to one beam in the kth identified beam group, wherein a bit value of 0 indicating the corresponding beam is prohibited while a bit value of 1 indicating the corresponding beam is allowed, or vis versa.

In one embodiment, the CBSR information that configures the UE with amplitude restrictions for the subset of beams associated to each of the one or more of the plurality of NZP CSI-RS resources comprises a concatenation of bit strings for all of the one or more of the plurality of NZP CSI-RS resources comprising, for each nth NZP CSI-RS resource,

$${B}_{G}^{( n )} {B}_{1}^{( n )} {B}_{2}^{( n )} {B}_{3}^{( n )} {B}_{4}^{( n )} ,$$

where

$${B}_{G}^{( n )}$$

identifies four beam groups for the nth NZP CSI-RS resource and

$${B}_{k}^{( n )}$$

indicates amplitude restrictions for beams in the kth (k∈(0, 1, 2, 3)) identified beam group for the nth NZP CSI-RS resource. In one embodiment,

$${B}_{k}^{( n )}$$

comprises N₁N₂ bits each associated to one beam in the kth identified beam group for the nth NZP CSI-RS resource.

In one embodiment, the amplitude restrictions comprise hard restrictions and/or soft restrictions, where a beam's amplitude is not allowed to exceed a threshold and in case of hard restrictions, the threshold is either one (i.e., without restriction) or zero (i.e., the beam is prohibited) and in case of soft restrictions, the threshold can be between zero and one.

In one embodiment, the amplitude of a beam is, optionally, evaluated at each layer, wherein the amplitude of a beam at each layer is defined as one of: (a) an average amplitude over the selected FD basis vectors of the coefficients associated to the beam and the layer at one antenna polarization; (b) an amplitude corresponding to a normalized total power of the coefficients associated to the beam and the layer at one antenna polarization with respect to a maximum total power of coefficients associated to all selected beams and the layer at one antenna polarization per NZP CSI-RS resource among all the subset of the plurality of NZP CSI-RS resources; or (c) an amplitude corresponding to a normalized total power of the coefficients associated to the beam and the layer at both antenna polarizations with respect to a maximum total power of coefficients associated to all selected beams and the layer per NZP CSI-RS resource among all the subset of the plurality of NZP CSI-RS resources.

In one embodiment, a restriction type of the amplitude restrictions is the same for all of the plurality of NZP CSI-RS resources.

In one embodiment, a restriction type of the amplitude restrictions is different for different ones of the plurality of NZP CSI-RS resources.

Corresponding embodiments of a UE are also disclosed. In one embodiment, a UE comprises a communication interface comprising a transmitter and a receiver, and processing circuitry associated with the communication interface. The processing circuitry is configured to cause the UE to receive, from a network node, configuration information that configures the UE with a plurality of NZP CSI-RS resources each with 2N₁N₂ CSI-RS antenna ports, for CJT CSI feedback, wherein N₁ and N₂ are positive integers. The processing circuitry is further configured to cause the UE to receive, from the network node, CBSR information for one or more of the plurality of NZP CSI-RS resources that configures the UE with amplitude restrictions for a subset of spatial vectors or beams on a per NZP CSI-RS resource basis. The processing circuitry is further configured to cause the UE to report, to the network node, CSI based on the configuration information and the CBSR information. The CSI comprises information about a number of layers and a subset of the plurality of NZP CSI-RS resources and, for each of the subset of the plurality of NZP CSI-RS resources, information for one or more selected SD basis vectors or beams. The CSI further comprises, for each of the number of layers, one or more selected FD basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

Embodiments of a method performed by a network node are also disclosed. In one embodiment, a method performed by a network node comprises sending, to a UE, configuration information that configures the UE with a plurality of NZP CSI-RS resources each with 2N₁N₂ CSI-RS antenna ports, for CJT CSI feedback, wherein N₁ and N₂ are positive integers. The method further comprises ending, to the UE, CBSR information for one or more of the plurality of NZP CSI-RS resources that configures the UE with amplitude restrictions for a subset of spatial vectors or beams on a per NZP CSI-RS resource basis. The method further comprises receiving, from the UE, CSI based on the configuration information and the CBSR information. The CSI comprises information about a number of layers and a subset of the plurality of NZP CSI-RS resources and, for each of the subset of the plurality of NZP CSI-RS resources, information for one or more selected SD basis vectors or beams. The CSI further comprises, for each of the number of layers, one or more selected FD basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

Corresponding embodiments of a network node are also disclosed. In one embodiment, a network node comprises a communication interface and processing circuitry associated with the communication interface. The processing circuitry is configured to cause the network node to send, to a UE, configuration information that configures the UE with a plurality of NZP CSI-RS resources each with 2N₁N₂ CSI-RS antenna ports, for CJT CSI feedback, wherein N₁ and N₂ are positive integers. The processing circuitry is further configured to cause the network node to send, to the UE, CBSR information for one or more of the plurality of NZP CSI-RS resources that configures the UE with amplitude restrictions for a subset of spatial vectors or beams on a per NZP CSI-RS resource basis. The processing circuitry is further configured to cause the network node to receive, from the UE, CSI based on the configuration information and the CBSR information. The CSI comprises information about a number of layers and a subset of the plurality of NZP CSI-RS resources and, for each of the subset of the plurality of NZP CSI-RS resources, information for one or more selected SD basis vectors or beams. The CSI further comprises, for each of the number of layers, one or more selected FD basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of spatial multiplexing, where an information carrying symbol vector s is multiplied by an N_{T}×r (rows×columns) precoding matrix or precoder W, which serves to distribute the transmit energy on the N_{T} transmit antenna ports in r “virtual” spatial directions, each associated to a data stream, such that they can be distinguished at the User Equipment (UE);

FIG. 2 illustrates an example of a 4×4 (i.e., N₁×N₂) antenna array with dual-polarized antenna elements (i.e., Nₚ=2);

FIG. 3 illustrates an example of Codebook Subset Restriction (CBSR) for a New Radio (NR) type II Codebook (CB) with (N₁, N₂)=(2,4) and (O₁, O₂)=(4,4);

FIG. 4 illustrates that, in case of soft beam restriction, the amplitude restriction threshold is effectively with respect to the strongest beam in case NR Rel-15 type II CBSR and the strongest beam and Frequency Domain (FD) basis vector pair in case of Rel-16 enhanced type II CBSR;

FIG. 5 illustrates an example of downlink Coherent Joint Transmission (CJT) from multiple Transmission and Reception Points (TRPs) by extending Rel-16 and Rel-17 enhanced type II codebook across multiple TRPs;

FIG. 6 illustrates an example of CJT over multiple TRPs with beam combining precoders feedback from a UE, in accordance with an embodiment of the present disclosure;

FIG. 7 illustrates an example of CBSR for CJT based on refinement of Rel-16 enhanced type II codebook, in accordance with an embodiment of the present disclosure;

FIG. 8 illustrates the operation of a network node and a UE in accordance with at least some embodiments of the present disclosure;

FIG. 9 shows an example of a communication system in accordance with some embodiments;

FIG. 10 shows a UE in accordance with some embodiments;

FIG. 11 shows a network node in accordance with some embodiments;

FIG. 12 is a block diagram of a host, which may be an embodiment of the host of FIG. 9, in accordance with various aspects described herein;

FIG. 13 is a block diagram illustrating a virtualization environment in which functions implemented by some embodiments may be virtualized; and

FIG. 14 shows a communication diagram of a host communicating via a network node with a UE over a partially wireless connection in accordance with some embodiments.

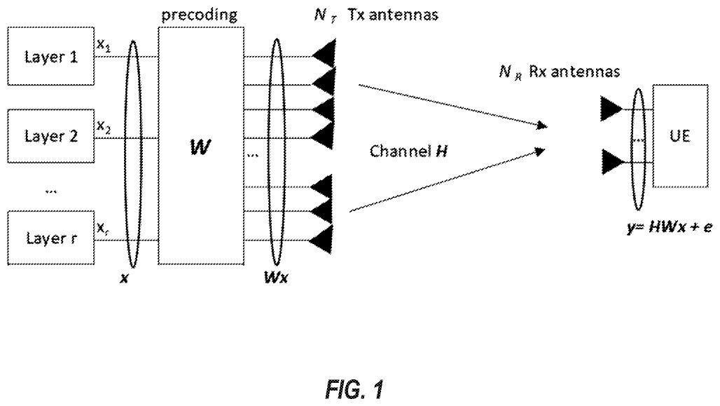

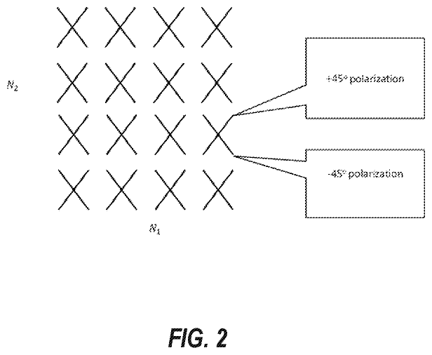

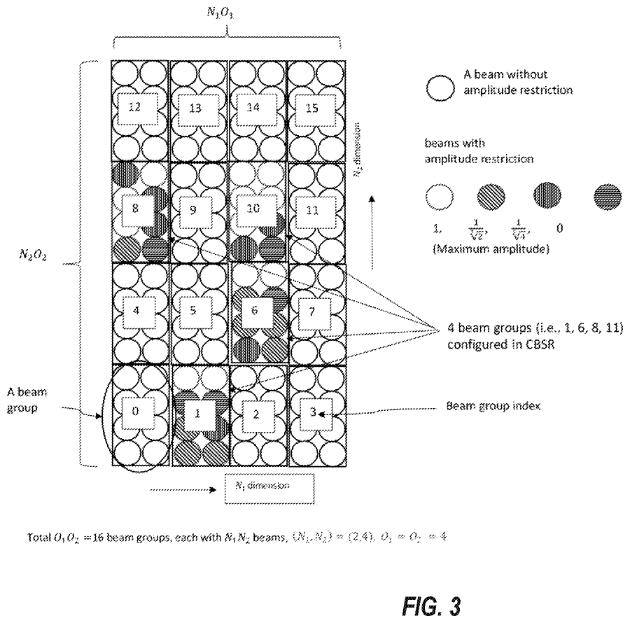

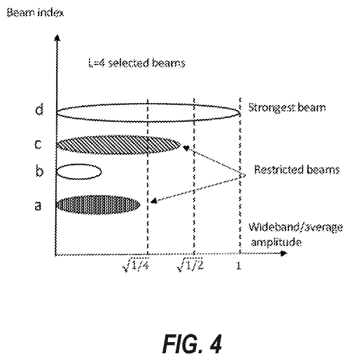

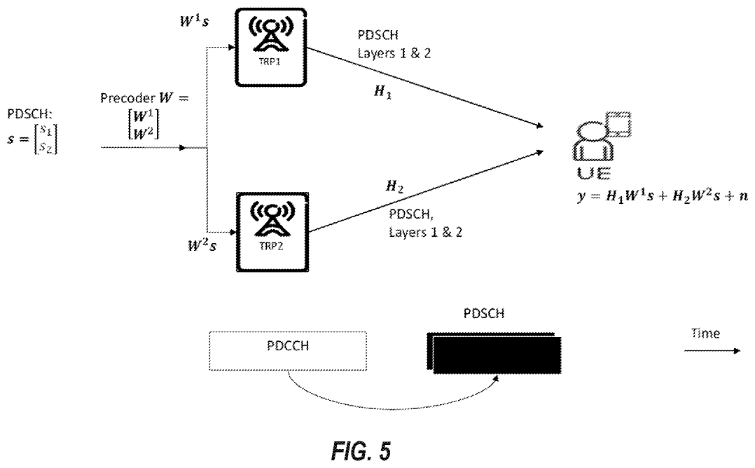

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

There currently exist certain challenge(s). One issue with the type II codebook extension for Coherent Joint Transmission (CJT) is how to configure and signal Codebook Subset Restriction (CBSR).

Another issue with existing CBSR for all type II codebooks is that the amplitude of a beam in a precoder is normalized by the amplitude of the strongest beam in the precoder, and the normalize amplitude to compared to a threshold. One of the use cases of CBSR is to reduce or avoid interference at certain directions to neighbor cells. With the existing CBSR, only relative beam amplitude with respect to the strongest beam in a precoder is compared to a threshold and thus, it is hard to configure soft amplitude restriction to meet certain interference expectation at a direction, e.g., −6 decibels (dB) below a maximum value.

Furthermore, when a User Equipment (UE) supports only hard restriction, two bits are still used to configure the amplitude threshold, which is a waste of resources.

Certain aspects of the disclosure and their embodiments may provide solutions to these or other challenges. Embodiments of systems and methods for configuring CBSR for CJT Channel State Information (CSI) feedback based on refinements of Rel-16 enhanced type II codebook over multiple TRPs are disclosed. In one embodiment, a method for configuring CBSR for CJT CSI feedback based on refinements of Rel-16 enhanced type II codebook over multiple TRPs comprises one or more of the following:
A network node configures a UE with N_{TRP} Non-Zero Power (NZP) CSI Reference Signal (CSI-RS) resources, each with 2N₁N₂ CSI-RS antenna ports where half of the antenna ports are at one polarization and the remaining half at a different polarization, for CJT CSI feedback.
The network node configures amplitude restrictions, either hard or soft restrictions, for a subset of beams associated to each of the N_{TRP} NZP CSI-RS resources.
   In case of hard restriction, a beam is either allowed or not allowed to be selected for CJT CSI.
   In case of soft restriction, a beam's amplitude is not allowed to exceed a threshold.
      A beam's amplitude can be based on one of:
         Average power across all selected FD basis vectors associated to the beam for each polarization;
         Normalized total power across all selected FD basis vectors associated to the beam for each polarization;
         Normalized total power across all selected FD basis vectors and polarization associated to the beam.
   The configuration comprises a bit string,

$${B}_{G}^{( n )} {B}_{1}^{( n )} {B}_{2}^{( n )} {B}_{3}^{( n )} {B}_{4}^{( n )} ,$$

for the nth NZP CSI-RS resource, where

$${B}_{G}^{( n )}$$

identities tour beam groups and Bₖ⁽ⁿ⁾ indicates the thresholds for beams in the kth (k∈(0, 1, 2, 3)) identified beam group, where there is one bit per beam in case of hard restriction and two bits per beam in case of soft restriction.
   Alternatively, a concatenated bit string may be configured for all TRPs as

$$\{ {B}_{G}^{( 1 )} {B}_{1}^{( 1 )} {B}_{2}^{( 1 )} {B}_{3}^{( 1 )} {B}_{4}^{( 1 )} … {B}_{G}^{( {n}_{T R P} )} {B}_{1}^{( {n}_{T R P} )} {B}_{2}^{( {n}_{T R P} )} {B}_{3}^{( {n}_{T R P} )} {B}_{4}^{( {n}_{T R P} )} \} .$$

The UE reports CJT CSI by selecting a set of beams across the N_{TRP} NZP CSI-RS resources and according to the CBRS configuration.

Embodiments of the present disclosure may include one or more of the following aspects:
Configured CBSR in a per TRP/NZP CSI-RS resource basis for CJT CSI feedback with multiple TRPs/NZP CSI-RS resources, i.e., for each TRP, a subset of beams may be restricted and different beams may be configured for different TRPs.
One bit may be used to indicate the threshold for each restricted beam in case of hard restriction.
   The restriction type (i.e., hard or soft) can be the same for all TRPs or different for different TRPs.
In case of soft amplitude restriction, one of three definitions of beam amplitude may be used, i.e.
   Average amplitude across selected FD basis vectors associated to a beam at each polarization,
   Normalized amplitude corresponding to sum power over all selected FD basis vectors associated to a beam, or
   Normalized amplitude corresponding to sum power over all selected FD basis vectors and polarizations associated to a beam.
The CBSR configuration for all TRPs can be a single concatenated bit string B⁽¹⁾B⁽²⁾ . . . B^{(N}^{_{TRP)}}, where

$${B}^{( n )} = {B}_{G}^{( n )} {B}_{1}^{( n )} {B}_{2}^{( n )} {B}_{3}^{( n )} {B}_{4}^{( n )}$$

is CBSR bit string for the nth TRP.

Certain embodiments may provide one or more of the following technical advantage(s). Embodiments of the present disclosure may allow flexible configuration of beams to be restricted for different TRPs to meet different needs in different deployment scenarios where the antenna heights and orientations may be different.

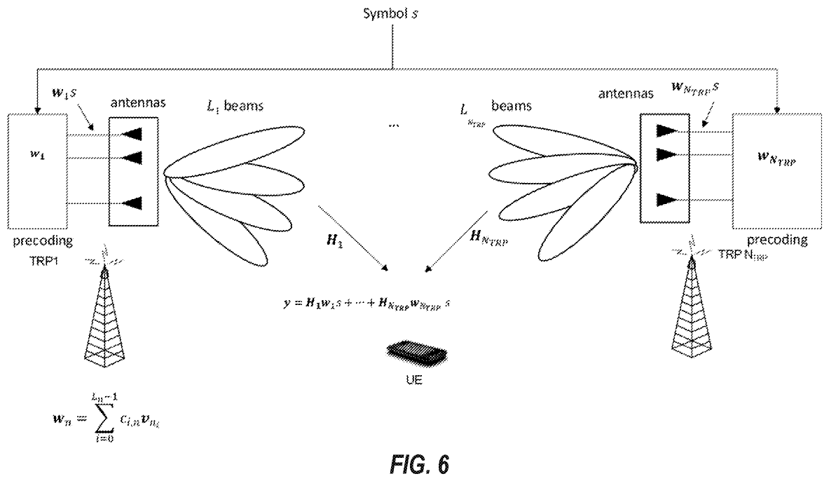

An example of CJT over multiple TRPs with beam combining precoders feedback from a UE is illustrated in FIG. 6, where a modulation symbol s is transmitted over multiple TRPs. Before transmission, the modulation symbol is precoded at each TRP, and the precoded symbol is then transmitted over the antennas at each TRP. The precoders are used to ensure that the symbol is coherently combined at the UE.

Each precoder consists of a combination of multiple Spatial Domain (SD) DFT vectors each forming a spatial beam. The SD vectors and the combination coefficients are selected and reported by a UE as part of CJT CSI feedback based on measurements of the downlink (DL) channels across all the TRPs. The measurements are performed over multiple CSI-RS resources each transmitted from one of the TRPs.

For symbols transmitted in different subbands, different precoders may be used. Also, different precoders are used for symbols belonging to different Multiple-Input Multiple-Output (MIMO) layers.

A CJT precoding matrix Wₗ for layer l (l=1, . . . , v) over N₃ PMI subbands and N_{TRP} TRPs (or NZP CSI-RS resources) can be expressed as

$${W}^{l} = [ \begin{matrix}{W}_{1} \\ {W}_{2}^{l} \\ … \\ {W}_{{N}_{TRP}}^{l}\end{matrix} ] \qquad Eq . 1$$

where

$${W}_{n}^{l} ( n = 1 , … , {N}_{TRP} )$$

is me precoding matrix associated to the nth NZP CSI-RS resource (or TRP) and is given by

$${W}_{n}^{l} = [ {w}_{l , n}^{( 0 )} … {w}_{l , n}^{( {N}_{3} - 1 )} ] = {W}_{1 , n} {\tilde{W}}_{2 , l , n} {W}_{f , l , n}^{H} \qquad Eq . 2$$

where

$${w}_{l , n}^{( t )}$$

is a P_{CSI-RS,n}×1 precoding vector associated to the nth CSI-RS resource at PMI subband t∈{0, 1, . . . , N₃−1} for layer l, where P_{CSI-RS,n}=2N_{1,n}N_{2,n} is the number of CSI-RS ports in the n^{th} NZP CSI-RS resource, and N_{1,n} and N_{2,n} are the number of antenna ports in a first and a second dimension. Note that the number of CSI-RS ports in different NZP CSI-RS resources can be the same or different.

$${W}_{1 , n} = [ \begin{matrix}{v}_{{m}_{1}^{( 0 )} , {m}_{2}^{( 0 ) , … ,}}^{n} {v}_{{m}_{1}^{( {L}_{n} - 1 )} , {m}_{2}^{( {L}_{n} - 1 )}}^{n} & 0 \\ 0 & {v}_{{m}_{1}^{( 0 )} , {m}_{2}^{( 0 ) , … ,}}^{n} {v}_{{m}_{1}^{( {L}_{n} - 1 )} , {m}_{2}^{( {L}_{n} - 1 )}}^{n}\end{matrix} ]$$

is a size P_{CSI-RS,n}×2Lₙ matrix associated with the nth NZP CSI-RS resource, where

$$\{ {v}_{{m}_{1 , n}^{( 0 )} , {m}_{2 , n}^{( 0 )}}^{( n )} , … , {v}_{{m}_{1 , n}^{( {l}_{n} - 1 )} , {m}_{2 , n}^{( {l}_{n} - 1 )}}^{( n )} \}$$

is a set of size P_{CSI-RS,n}/2×1 2-D spatial DFT vectors or beams and

$${v}_{{m}_{1 , n}^{( i )} , {m}_{2 , n}^{( i )}}^{( 11 )} = {[ {u}_{{m}_{2}^{( i )}}^{( n )} {e}^{j \frac{2 π {m}_{1 , n}^{( i )}}{{O}_{1 , n} {N}_{1 , n}}} {u}_{{m}_{2}^{( i )}}^{( n )} … {e}^{j \frac{2 π {m}_{1 , n}^{( i )} ( {N}_{1 , n} - 1 )}{{O}_{1 , n} {N}_{1 , n}}} {u}_{{m}_{2}^{( i )}}^{( n )} ]}^{T}$$

$${u}_{{m}_{2}^{( i )}}^{( n )} = {[ 1 {e}^{j \frac{2 π {m}_{2}^{( i )}}{{O}_{2 , n} {N}_{2 , n}}} … {e}^{j \frac{2 π {m}_{2}^{( i )} ( {N}_{2 , n} - 1 )}{{O}_{2 , n} {N}_{2 , n}}} ]}^{T}$$

if N_{2,n}>1 and

$${u}_{{m}_{2}^{( i )}}^{( n )} = 1$$

if

$${N}_{2 , n} = 1$$

$${m}_{1 , n}^{( i )} = {O}_{1 , n} {n}_{1 , n}^{( i )} + {q}_{1 , n} , {m}_{2 , n}^{( i )} = {O}_{2 , n} {n}_{2 , n}^{( i )} + {q}_{2 , n} , {n}_{1 , n}^{( i )} ∈ \{ 0 , 1 , … , {N}_{1 , n} - 1 \} ,$$

$${n}_{2 , n}^{( i )} ∈ \{ 0 , 1 , … , {N}_{2 , n} - 1 ] ,$$

q_{1,n}∈{0, 1, . . . , O_{1,n}−1}, q_{2,n}∈{0, 1, . . . , O_{2,n}−1}, i=0, 1, . . . Lₙ−1, and O_{1,n} and O_{2,n} are the oversampling factors along dimensions of N_{1,n} and N_{2,n}, respectively.

$${W}_{f , l , n} = [ {y}_{l , n}^{( 0 )} , {y}_{l , n}^{( 1 )} , … , {y}_{l , n}^{( {M}_{v , n} - 1 )} ]$$

is a size N₃×M_{v,n} Frequency Domain (FD) compression matrix comprising M_{v,n} FD basis vectors associated to the nth CSI-RS resource, where

$${y}_{l , n}^{( f )} ∈ \{ {y}_{0} {y}_{1} … {y}_{{N}_{3} - 1} \} ,$$

and yₖ=[y_{k,0}, y_{k,1}, . . . , y_{k,N}_{₃}₋₁]^{T} and y_{k,t}=e^{-j2πkt/N}^{₃}, k, t=0, 1, . . . , N₃−1.
\tilde{W}_{2,l,n}=[c_{l,i,f,p,n}) i=0, 1, . . . , 2Lₙ−1; f=0, 1, . . . , M_{v,n}−1; p=0, 1] is a size 2Lₙ×M_{v,n} coefficient matrix associated to the nth CSI-RS resource.

In some embodiments, the FD compression matrix is common across the CSI-RS resources or TRPs in which case, W_{f,l} is independent of n (i.e., W_{f,l}=W_{f,l,1}=W_{f,l,2}= . . . =W_{f,l,N}_{_{TRP}}) and Mᵥ=M_{v,1}=M_{v,2}= . . . =M_{v,N}_{_{TRP}}.

In an alternative expression, each of the precoding vectors

$${w}_{l , n}^{( t )}$$

can be expressed as follows:

$${w}_{l , n}^{( t )} = [ \begin{matrix}{w}_{l , 0 , n}^{( t )} \\ {w}_{l , 1 , n}^{( t )}\end{matrix} ] , n = 1 , … , {N}_{TRP} . \qquad Eq . 3$$

$${w}_{l , p , n}^{( t )} = {\sum }_{i = 0}^{{L}_{n} - 1} {v}_{{m}_{1 , n}^{( i )} , {m}_{2 , n}^{( i )}}^{( n )} {\sum }_{f = 0}^{{M}_{ν , n} - 1} {c}_{l , i , f , p , n} {y}_{t , l , n}^{( f )} , p = 0 , 1 \qquad Eq . 4$$

$${y}_{t , l , n}^{( f )} = {e}^{j \frac{2 π {tn}_{3 , l , n}^{( f )}}{{N}_{3}}} \qquad Eq . 5$$

$${c}_{l , i , f , p , n} = {p}_{l , p , n}^{( 1 )} {p}_{l , i , f , p , n}^{( 2 )} {φ}_{l , i , f , p , n} \qquad Eq . 6$$

where

$${w}_{l , n}^{( t )}$$

is the precoder associated with the nth CSI-RS resource or TRP and consists of two parts,

$${w}_{l , 0 , n}^{( t )}$$

for a second polarization and

$${w}_{l , 1 , n}^{( t )}$$

for a second polarization

$${n}_{3 , l , n}^{( f )} ∈ \{ 0 , 1 , … , {N}_{3} - 1 \}$$

is a FD basis vector index of the f^{th} selected FD basis vector associated to the nth CSI-RS resource

$${c}_{l , i , f , p , n} = {p}_{l , p , n}^{( 1 )} {p}_{l , i , f , p , n}^{( 2 )} {φ}_{l , i , f , p , n}$$

is the coefficient of \tilde{W}_{2,l,n} associated with layer l, the i^{th} beam, the f^{th} FD basis vector, polarization with index p, and the nth CSI-RS resource;

$${p}_{l , p , n}^{( 1 )}$$

is the reference amplitude associated with layer l, polarization index p, and CSI-RS resource index n, and

$${p}_{l , i , f , p , n}^{( 2 )}$$

is the amplitude with respect to

$${p}_{l , p , n}^{( 1 )}$$

associated with layer l, the i^{th} selected spatial beam, the f^{th} selected FD basis vector, polarization index p, and CSI-RS resource index n. φ_{l,i,f,p,n} is the co-phase factor associated to coefficient c_{l,i,f,p,n}.

Note that UE may select N (N≤N_{TRP}) out of the N_{TRP} configured CSI-RS resources or TRPs and report W^{l} based on the N selected CSI-RS resources or TRPs. In that case, W^{l} contains precoding matrices associated to the associated to the N selected TRPs.

### CBSR for CJT

In some scenarios, some spatial beams or SD vectors can be restricted, either hard restricted such that the beams are prohibited to be selected or soft restricted in which the amplitudes of the beams are not allowed to exceed certain thresholds.

In one embodiment, the restricted spatial beams or SD vectors are configured and signaled to a UE in a per TRP or per CSI-RS resource basis. This per TRP CBSR allows more flexible beam restriction as the antennas in different TRPs may be at different heights and/or with different orientations (e.g., down tilts) and thus the restriction may need to be applied to different beams for different TRPs.

For each TRP or CSI-RS resource, 4 beam groups are indicated for beam restriction and 2 bits for each beam in each of the 4 beam groups are signaled to the UE. For the nth TRP or CSI-RS resource, the average amplitude for beam i at polarization p∈(0,1) and layer l is defined as

$${a}_{avg} ( i , p , n , l ) = \sqrt{\frac{1}{{\sum }_{f = 0}^{{M}_{v} - 1} {k}_{l , i , f , p , n}^{( 3 )}} {\sum }_{f = 0}^{{M}_{v} - 1} {{k}_{l , i , f , p , n}^{( 3 )} ( {p}_{l , p , n}^{( 1 )} {p}_{l , i , f , p , n}^{( 2 )} )}^{2}}$$

where

$${k}_{l , i , f , p , n}^{( 3 )}$$

∈(0,1) is the bit indicating whether or not the coefficient associated to beam i of the nth TRP and FD basis vector f at polarization p and layer l is a non-zero coefficient that is reported. When beam i of the nth TRP is in one of the four beam groups configured for CBSR, the condition a_{avg}(i, p, n, l)≤γ_{i,p,n} needs to be met, where

$${γ}_{i , p , n} ∈ ( 0 , \sqrt{\frac{1}{4}} , \sqrt{\frac{1}{2}} , 1 ) .$$

In the above, the soft beam restriction is with respect to the strongest beam and FD basis vector pair, which may be selected from a different TRP. The practical usefulness of such a soft beam restriction is not very clear because beams in different TRPs do not share power and, unlike in the single TRP case, restricting one beam in one TRP in CJT does not automatically boost beam transmit power in other TRPs.

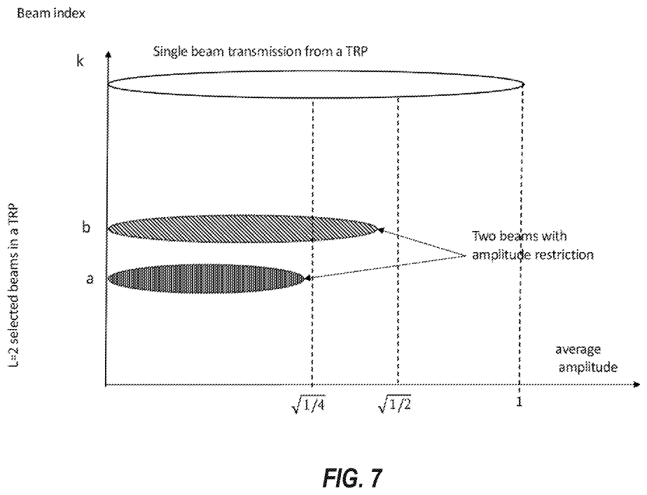

So alternatively, in another embodiment, soft beam restriction is with respect to a DL transmission with a single beam where all available power is transmitted in a single beam. This is illustrated in FIG. 7, where L=2 beams {a,b} are selected by the UE for CJT from a TRP. In other words, FIG. 7 illustrates an example of CBSR for CJT based on refinement of Rel-16 enhanced type II codebook. Beam k is illustrated as when a hypothetical single beam transmission is performed with an available transmission power. When multiple beams are used for DL transmission from a TRP, the available transmission power is distributed among the multiple beams. In this example, beams a and b are restricted beams configured in CBSR with soft restriction \sqrt{¼} and \sqrt{½}, respectively. The restriction is with respect to the single beam transmission, which has an amplitude of 1. In this case, the amplitude for beam i at polarization p∈(0,1) and layer l can be defined as

$$\tilde{a} ( i , p , n , l ) = \sqrt{\frac{{\sum }_{f = 0}^{{M}_{v} - 1} {{k}_{l , i , f , p , n}^{( 3 )} ( {p}_{l , p , n}^{( 1 )} {p}_{l , i , f , p , n}^{( 2 )} )}^{2}}{{max}_{m , p} \{ {\sum }_{j = 0}^{{L}_{m} - 1} {\sum }_{f = 0}^{{M}_{v} - 1} {{k}_{l , i , f , p , m}^{( 3 )} ( {p}_{l , p , m}^{( 1 )} {p}_{l , i , f , p , m}^{( 2 )} )}^{2} , m = 1 , … , N \}}}$$

where

$${max}_{m , p} \{ {\sum }_{j = 0}^{{L}_{m} - 1} {\sum }_{f = 0}^{{M}_{v} - 1} {{k}_{l , i , f , p , m}^{( 3 )} ( {p}_{l , p , m}^{( 1 )} {p}_{l , j , f , p , m}^{( 2 )} )}^{2} ,$$

m=1, . . . , N} corresponds to the maximum power allocation in a CJT precoder to a TRP among all the selected TRPs at one polarization and layer l, which is equivalent to the maximum transmit power when a single beam is selected, and

$${\sum }_{f = 0}^{{M}_{v} - 1} {{k}_{l , i , f , p , n}^{( 3 )} ( {p}_{l , p , n}^{( 1 )} {p}_{l , i , f , p , n}^{( 2 )} )}^{2}$$

corresponds to the power allocation in a CJT precoder to beam i at polarization p in the nth TRP over all subbands. When beam i is a restricted beam, then ã(i, p, n, l)≤γ_{i,p,n}, where

$${γ}_{i , p , n} ∈ ( 0 , \sqrt{\frac{1}{4}} , \sqrt{\frac{1}{2}} , 1 ) .$$

In another embodiment, for the nth TRP or CSI-RS resource, the amplitude for beam i and layer l may be defined as the total across both polarizations, i.e., the amplitude corresponding to the total wideband power across both polarizations associated to the beam with respect to the maximum total wideband transmit power across all beams and polarizations per TRP among all the TRPs.

$$\tilde{a} ( i , n , l ) = \sqrt{\frac{{\sum }_{p = 0}^{1} {\sum }_{f = 0}^{{M}_{v} - 1} {{k}_{l , i , f , p , n}^{( 3 )} ( {p}_{l , p , n}^{( 1 )} {p}_{l , i , f , p , n}^{( 2 )} )}^{2}}{\begin{matrix}{max}_{m} \{ {\sum }_{p = 0}^{1} {\sum }_{j = 0}^{{L}_{m} - 1} {\sum }_{f = 0}^{{M}_{v} - 1} {k}_{l , i , f , p , m}^{( 3 )} \\ {( {p}_{l , p , m}^{( 1 )} {p}_{l , j , f , p , m}^{( 2 )} )}^{2} , m = 1 , … , N \}\end{matrix}}}$$

When beam i is a restricted beam, then ã(i, n, l)≤γ_{i,n}, where γ_{i,n}

$$∈ ( 0 , \sqrt{\frac{1}{4}} , \sqrt{\frac{1}{2}} , 1 ) .$$

RRC configuration: For the above per TRP CBSR methods, a bit string

$${B}_{G}^{( n )} {B}_{1}^{( n )} {B}_{2}^{( n )} {B}_{3}^{( n )} {B}_{4}^{( n )}$$

may be used to configure CBSR for the nth TRP, where

$${B}_{G}^{( n )}$$

contains

$$⌈ {log}_{2} ( \begin{matrix}{O}_{1} {O}_{2} \\ 4\end{matrix} ) ⌉ bits$$

and is used to indicate 4 selected beam groups out of O₁O₂ beam groups associated to the nth TRP or CSI-RS resource,

$${B}_{k}^{( n )} = {b}_{k , 2 {N}_{1} {N}_{2} - 1}^{( n )} … {b}_{k , 0}^{( n )}$$

contains 2N₁N₂ bits or N₁N₂ bit pairs where the ith pair,

$${b}_{k , 2 i + 1}^{( n )} {b}_{k , 2 i}^{( n )} ,$$

is associated to the ith beam within the kth selected beam group of the nth TRP and is used to indicate one of the amplitude restrictions

$$( i . e . , 0 , \sqrt[2]{1 / 4} , \sqrt[2]{1 / 2} , 1 )$$

for the ith beam, where i=N₁x₂+x₁, x₁∈(0, 1, . . . , N₁−1) and x₂∈(0, 1, . . . , N₂−1), k=0, 1, 2, 3, and n=1, . . . , n_{TRP}.

In another embodiment, a single bit string may be used to configure CBSR for all TRPs by concatenating the CBSR bits for each TRP as follows:

$${B}_{G}^{( 1 )} {B}_{1}^{( 1 )} {B}_{2}^{( 1 )} {B}_{3}^{( 1 )} {B}_{4}^{( 1 )} {B}_{G}^{( 2 )} {B}_{1}^{( 2 )} {B}_{2}^{( 2 )} {B}_{3}^{( 2 )} {B}_{4}^{( 2 )} … {B}_{G}^{( {N}_{TRP} )} {B}_{1}^{( {N}_{TRP} )} {B}_{2}^{( {N}_{TRP} )} {B}_{3}^{( {N}_{TRP} )} {B}_{4}^{( {N}_{TRP} )}$$

In a further embodiment, only hard beam restrictions may be supported in CJT where for each beam at polarization p∈(0,1) in one of the four beam groups configured for CBSR, only one bit can be used to indicate whether the beam is restricted/prohibited (i.e., γ_{i,p,n}=0 or γ_{i,n}=0) or not restricted (i.e., γ_{i,p,n}=1 or γ_{i,n}=1). Therefore, N₁N₂ bits are needed for

$${B}_{k}^{( n )} = ( k = 0 , 1 , 2 , 3 ; n = 1 , … , {N}_{TRP} ) ,$$

i.e.,

$${B}_{k}^{( n )} = {b}_{k , {N}_{1} {N}_{2} - 1}^{( n )} … {b}_{k , 0}^{( n )} ,$$

where

$${b}_{k , i}^{( n )} ( i = 0 , 1 , … , {N}_{1} {N}_{2} - 1 )$$

is used to indicates whether the ith beam is prohibited or not. This reduces the RRC signaling overhead for

$${B}_{k}^{( n )}$$

by half. In addition, it reduces the UE processing complexity associated with the soft amplitude restrictions, where multiple iterations may be needed in order to meet the soft amplitude restrictions, e.g., by re-selecting a set of new beams.

In yet another embodiment, soft beam restrictions may be applied for beams from a subset of CSI-RS resources (i.e., a subset of TRPs), and hard beam restriction may be applied for beams from the remaining CSI-RS resources.
For instance, let N′_{TRP} denote the number of CSI-RS resources (i.e., TRPs) to which soft beam restriction applies. In each of these N′_{TRP} CSI-RS resources there will be four beam groups configured for CBSR wherein there will be 2N₁N₂ bits for each of the four beam groups (i.e., there are N₁N₂ spatial beams in each beam group and 2 bits are included per spatial beam to configure the per beam soft restriction γ_{i,p,n} or

$${γ}_{i , n} ∈ ( 0 , \sqrt{\frac{1}{4}} , \sqrt{\frac{1}{2}} , 1 ) ) ,$$

Hence, there are 2N′_{TRP}N₁N₂ bits needed to indicate soft beam restriction over the N′_{TRP} CSI-RS resources.
In the remaining (N_{TRP}−N′_{TRP}) configured CSI-RS resources (i.e., TRPs), hard beam restriction applies. In these (N_{TRP}−N′_{TRP}) remaining CSI-RS resources, there will be four beam groups configured for CBSR wherein there will be N₁N₂ bits for each of the four beam groups (i.e., there are N₁N₂ spatial beams in each beam group and 1 bit is included per spatial beam to configure the per beam hard restriction γ_{i,p,n} Or γ_{i,n}∈(0, 1)). Hence, there are (N_{TRP}−N′_{TRP})N₁N₂ bits needed to indicate hard beam restriction over the (N_{TRP}−N′_{TRP}) remaining CSI-RS resources.
In total, there will be 2N′_{TRP}N₁N₂+(N_{TRP}−N′_{TRP})N₁N₂=(N_{TRP}+N′_{TRP})N₁N₂ bits needed to indicate soft and hard beam restrictions in this embodiment.
In some embodiments, the number N′_{TRP} of CSI-RS resources over which soft beam restriction can be applied is a UE capability and is report as part of UE capability reporting. As the needs to perform computation of α_{avg}(i, p, n, l) for CSI-RS resources over which soft beam restriction is applied, UEs with different computation capabilities will report different capability values for N′_{TRP}. That is, a more capable UE that can perform a_{avg}(i, p, n, l) computation over more CSI-RS resources will report a larger capability value for N′_{TRP} when compared to a UE that can perform a_{avg}(i, p, n, l) computation over a smaller number of CSI-RS resources.

In some cases, the coverage of different beams from different TRPs may have overlap. Then, it is also beneficial to limit the sum power/amplitude of the overlapped beams, for example, to avoid causing excessive interference when the overlapped beams are simultaneously selected. In one embodiment, the sum power of a subset of beams over the configured TRPs, or of a subset of the configured TRPs, does not exceed a configured limit. For example, let I′ be the set of beams whose sum power should be limited, e.g., I′={a, b}, where a and b denote two beams associated with two different CSI-RS resources, then

$${a}_{a v g} ( {I}^{′} , p , n , l ) = \sqrt{{\sum }_{{i ∈ {I}^{′}}^{}} \frac{1}{{\sum }_{f = 0}^{{m}_{v} - 1} {k}_{l . i , f , p , n}^{( 3 )}} {\sum }_{f = 0}^{{M}_{v} - 1} {{k}_{l , i , f , p , n}^{( 3 )} ( {p}_{l , p , n}^{( 1 )} {p}_{l , i , f , p , n}^{( 2 )} )}^{2}}$$

where a_{avg}(l′, p, n, l)≤γ_{I′,p,n}, where

$${γ}_{{I}^{′} , p , n} ∈ ( 0 , \sqrt{\frac{1}{4}} , \sqrt{\frac{1}{2}} , 1 ) .$$

In a dependent embodiment, the set I′ is configured to the UE, e.g., in a RRC message in codebook configurations.

In some embodiments, the CBSR is used to limit the sum power for the configured set of beams over both polarizations.

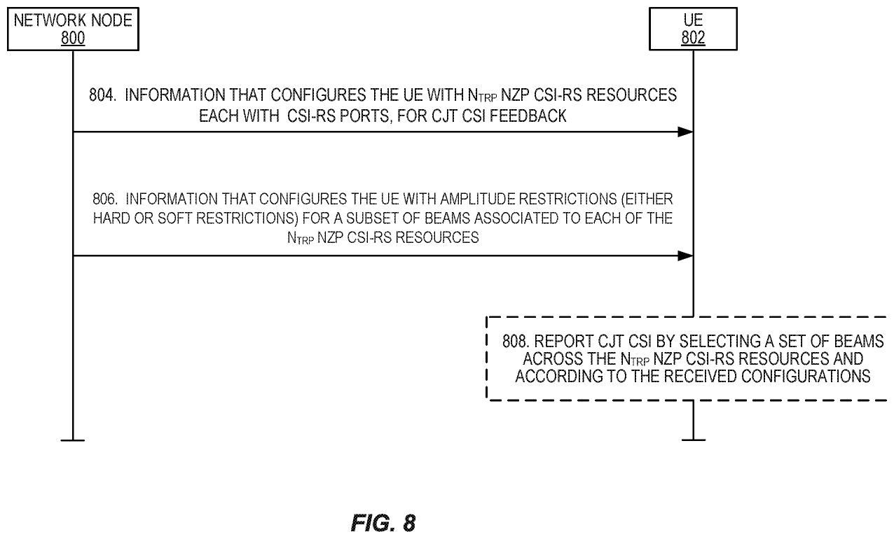

FIG. 8 illustrates the operation of a network node 800 and a UE 802 in accordance with at least some of the embodiments described herein. The network node 800 may be, for example, a base station such as, e.g., a gNB, a network node that performs some of the functionality of a base station such as, e.g., a gNB-Central Unit (CU) or gNB-Distributed Unit (DU), or some other Radio Access Network (RAN) node). As illustrated, the network node 800 sends, to the UE 802, information that configures the UE 802 with N_{TRP} NZP CSI-RS resources each with 2N₁N₂ CSI-RS antenna ports, for CJT CSI feedback (step 804). The CJT CSI comprises information about a number of layers and for each of the NZP CSI-RS resources and each layer, information for one or more selected SD basis vectors each representing a spatial beam, one or more selected FD basis vectors, and a set of normalized coefficients each associated to one pair of the one or more SD and FD basis vectors and each antenna polarization. In addition, the network node 800 sends, to the UE 802, (step 806). In case of a hard restriction, a beam is either allowed or not allowed to be selected for CJT CSI. In case of soft restriction, a beam's amplitude to not allowed to exceed a threshold. In one embodiment, a beam's soft amplitude restrictions is based on one of the following:
Average power across all selected FD basis vectors associated to the beam for each polarization
Normalized total power across all selected FD basis vectors associated to the beam for each polarization
Normalized total power across all selected FD basis vectors and polarization associated to the beam

In one embodiment, the information that configures the UE 802 with amplitude restrictions comprises a bit string,

$${B}_{G}^{( n )} {B}_{1}^{( n )} {B}_{2}^{( n )} {B}_{3}^{( n )} {B}_{4}^{( n )} ,$$

for the nth NZP CSI-RS resource, where

$${B}_{G}^{( n )}$$

identifies four beam groups and Bₖ⁽ⁿ⁾ indicates the thresholds for beams in the kth (k∈(0, 1, 2, 3)) identified beam group, where there is one bit per beam in case of hard restriction and 2 bits per beam in case of soft restriction, as described above. In another embodiment, the information that configures the UE 802 with amplitude restrictions comprises a concatenated bit string for all TRPs as

$$\{ {B}_{G}^{( 1 )} {B}_{1}^{( 1 )} {B}_{2}^{( 1 )} {B}_{3}^{( 1 )} {B}_{4}^{( 1 )} … {B}_{G}^{( {n}_{T R P} )} {B}_{1}^{( {n}_{T R P} )} {B}_{2}^{( {n}_{T R P} )} {B}_{3}^{( {n}_{T R P} )} {B}_{4}^{( {n}_{T R P} )} \} ,$$

as described above. Note that the restriction type (i.e., hard or soft) can be the same for all TRPs/NZP CSI-RS resources or different for different TRPs/NZP CSI-RS resources.

Optionally, the UE 802 reports CJT CSI by selecting a set of beams across the N_{TRP} NZP CSI-RS resources and according to the CBRS configuration (step 808).

### Further Description

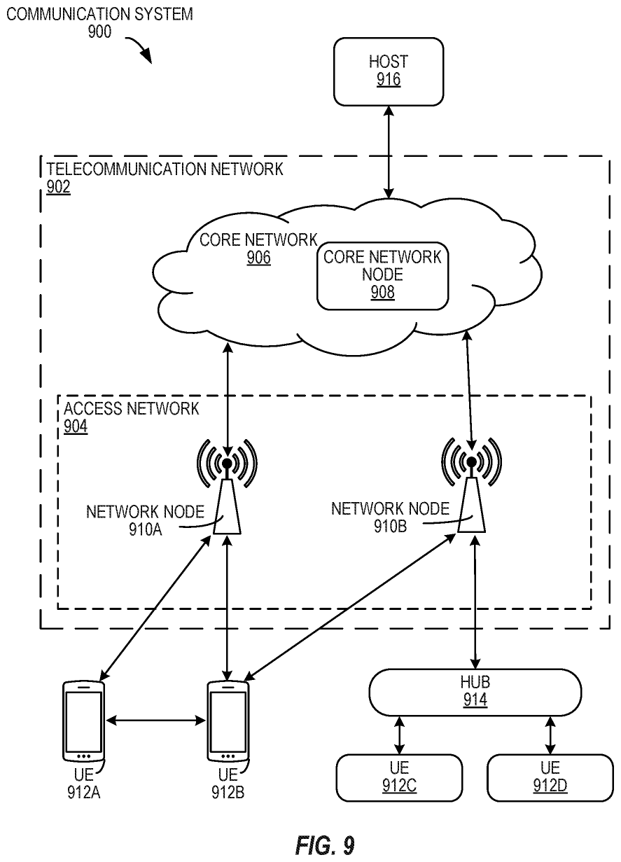

FIG. 9 shows an example of a communication system 900 in accordance with some embodiments.

In the example, the communication system 900 includes a telecommunication network 902 that includes an access network 904, such as a Radio Access Network (RAN), and a core network 906, which includes one or more core network nodes 908. The access network 904 includes one or more access network nodes, such as network nodes 910A and 910B (one or more of which may be generally referred to as network nodes 910), or any other similar Third Generation Partnership Project (3GPP) access node or non-3GPP Access Point (AP). The network nodes 910 facilitate direct or indirect connection of User Equipment (UE), such as by connecting UEs 912A, 912B, 912C, and 912D (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system 900 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 902 is a cellular network that implements 3GPP standardized features. Accordingly, the telecommunication network 902 may support network slicing to provide different logical networks to different devices that are connected to the telecommunication network 902. For example, the telecommunication network 902 may provide Ultra Reliable Low Latency Communication (URLLC) services to some UEs, while providing enhanced Mobile Broadband (cMBB) services to other UEs, and/or massive Machine Type Communication (mMTC)/massive Internet of Things (IoT) services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 914 communicates with the access network 904 to facilitate indirect communication between one or more UEs (e.g., UE 912C and/or 912D) and network nodes (e.g., network node 910B). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a Virtual Reality (VR) headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910B. The hub 914 may also allow for a different communication scheme and/or schedule between the hub 914 and UEs (e.g., UE 912C and/or 912D), and between the hub 914 and the core network 906. In other examples, the hub 914 is connected to the core network 906 and/or one or more UEs via a wired connection. Moreover, the hub 914 may be configured to connect to a Machine-to-Machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910B. In other embodiments, the hub 914 may be a non-dedicated hub—that is, a device which is capable of operating to route communications between the UEs and the network node 910B, but which is additionally capable of operating as a communication start and/or end point for certain data channels.

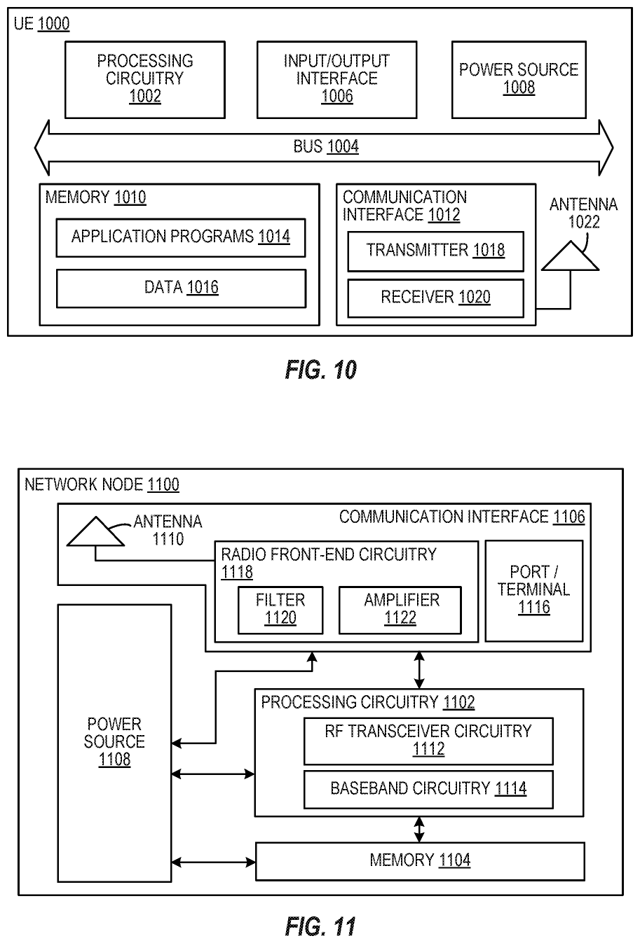

FIG. 10 shows a UE 1000 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1002 may include multiple Central Processing Units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging the power source 1008. Power circuitry may perform any formatting, converting, or other modification to the power from the power source 1008 to make the power suitable for the respective components of the UE 1000 to which power is supplied.

The memory 1010 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1010 may allow the UE 1000 to access instructions, application programs, and the like stored on transitory or non-transitory memory media, to off-load data, or to upload data. An article of manufacture, such as one utilizing a communication system, may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., the antenna 1022) and may share circuit components, software, or firmware, or alternatively be implemented separately.

In the illustrated embodiment, communication functions of the communication interface 1012 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1012, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 11 shows a network node 1100 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes processing circuitry 1102, memory 1104, a communication interface 1106, and a power source 1108. The network node 1100 may be composed of multiple physically separate components (e.g., a Node B component and an RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1100 may be configured to support multiple RATs. In such embodiments, some components may be duplicated (e.g., separate memory 1104 for different RATs) and some components may be reused (e.g., an antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1100.

The processing circuitry 1102 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1100 components, such as the memory 1104, to provide network node 1100 functionality.

In some embodiments, the processing circuitry 1102 includes a System on a Chip (SOC). In some embodiments, the processing circuitry 1102 includes one or more of Radio Frequency (RF) transceiver circuitry 1112 and baseband processing circuitry 1114. In some embodiments, the RF transceiver circuitry 1112 and the baseband processing circuitry 1114 may be on separate chips (or sets of chips), boards, or units, such as radio units and digital units. In alternative embodiments, part or all of the RF transceiver circuitry 1112 and the baseband processing circuitry 1114 may be on the same chip or set of chips, boards, or units.

The memory 1104 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and the memory 1104 are integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. The radio front-end circuitry 1118 comprises filters 1120 and amplifiers 1122. The radio front-end circuitry 1118 may be connected to the antenna 1110 and the processing circuitry 1102. The radio front-end circuitry 1118 may be configured to condition signals communicated between the antenna 1110 and the processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of the filters 1120 and/or the amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface 1106 may comprise different components and/or different combinations of components.

In certain alternative embodiments, the network node 1100 does not include separate radio front-end circuitry 1118; instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes the one or more ports or terminals 1116, the radio front-end circuitry 1118, and the RF transceiver circuitry 1112 as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, the communication interface 1106, and/or the processing circuitry 1102 may be configured to perform any receiving operations and/or certain obtaining operations described herein as being performed by the network node 1100. Any information, data, and/or signals may be received from a UE, another network node, and/or any other network equipment. Similarly, the antenna 1110, the communication interface 1106, and/or the processing circuitry 1102 may be configured to perform any transmitting operations described herein as being performed by the network node 1100. Any information, data, and/or signals may be transmitted to a UE, another network node, and/or any other network equipment.

The power source 1108 provides power to the various components of the network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid or an electricity outlet) via input circuitry or an interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

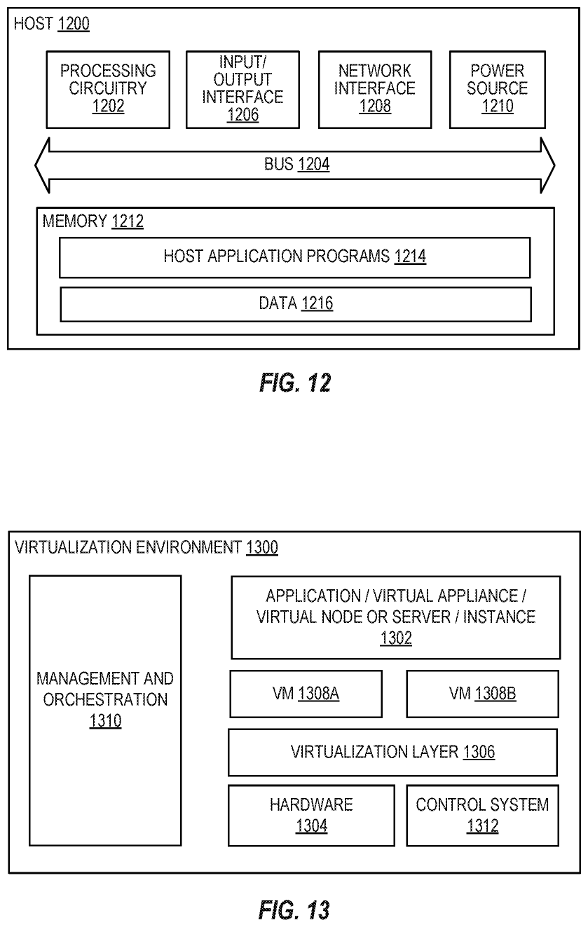

FIG. 12 is a block diagram of a host 1200, which may be an embodiment of the host 916 of FIG. 9, in accordance with various aspects described herein. As used herein, the host 1200 may be or comprise various combinations of hardware and/or software including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of the host 1200.

The memory 1212 may include one or more computer programs including one or more host application programs 1214 and data 1216, which may include user data, e.g. data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for Over-The-Top (OTT) services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or VM Monitors (VMMs)), provide VMs 1308A and 1308B (one or more of which may be generally referred to as VMs 1308), and/or perform any of the functions, features, and/or benefits described in relation with some embodiments described herein. The virtualization layer 1306 may present a virtual operating platform that appears like networking hardware to the VMs 1308.

The VMs 1308 comprise virtual processing, virtual memory, virtual networking, or interface and virtual storage, and may be run by a corresponding virtualization layer 1306. Different embodiments of the instance of a virtual appliance 1302 may be implemented on one or more of the VMs 1308, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1308 may be a software implementation of a physical machine that runs programs as if they were executing on a physical, non-virtualized machine. Each of the VMs 1308, and that part of the hardware 1304 that executes that VM, be it hardware dedicated to that VM and/or hardware shared by that VM with others of the VMs 1308, forms separate virtual network elements. Still in the context of NFV, a virtual network function is responsible for handling specific network functions that run in one or more VMs 1308 on top of the hardware 1304 and corresponds to the application 1302.

The hardware 1304 may be implemented in a standalone network node with generic or specific components. The hardware 1304 may implement some functions via virtualization. Alternatively, the hardware 1304 may be part of a larger cluster of hardware (e.g., such as in a data center or CPE) where many hardware nodes work together and are managed via management and orchestration 1310, which, among others, oversees lifecycle management of the applications 1302. In some embodiments, the hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1312 which may alternatively be used for communication between hardware nodes and radio units.

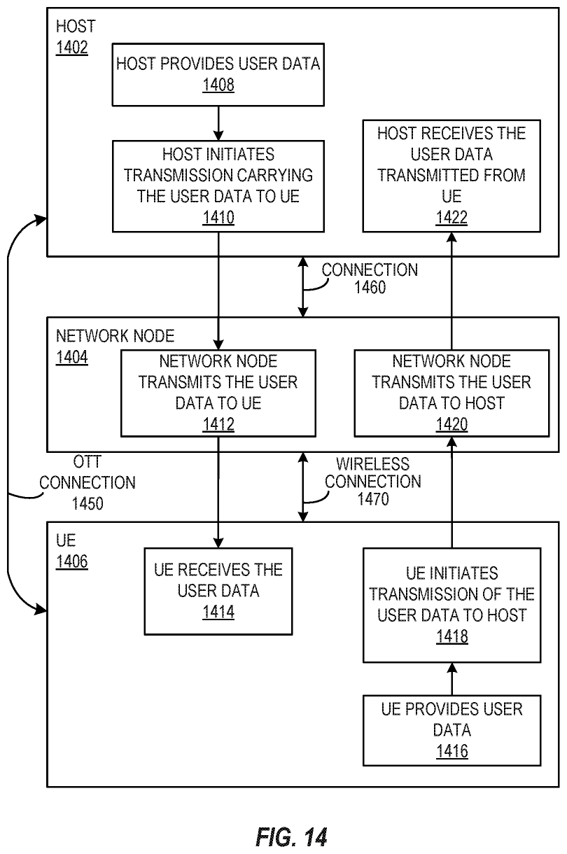

FIG. 14 shows a communication diagram of a host 1402 communicating via a network node 1404 with a UE 1406 over a partially wireless connection in accordance with some embodiments. Example implementations, in accordance with various embodiments, of the UE (such as the UE 912A of FIG. 9 and/or the UE 1000 of FIG. 10), the network node (such as the network node 910A of FIG. 9 and/or the network node 1100 of FIG. 11), and the host (such as the host 916 of FIG. 9 and/or the host 1200 of FIG. 12) discussed in the preceding paragraphs will now be described with reference to FIG. 14.

Like the host 1200, embodiments of the host 1402 include hardware, such as a communication interface, processing circuitry, and memory. The host 1402 also includes software, which is stored in or is accessible by the host 1402 and executable by the processing circuitry. The software includes a host application that may be operable to provide a service to a remote user, such as the UE 1406 connecting via an OTT connection 1450 extending between the UE 1406 and the host 1402. In providing the service to the remote user, a host application may provide user data which is transmitted using the OTT connection 1450.

The network node 1404 includes hardware enabling it to communicate with the host 1402 and the UE 1406 via a connection 1460. The connection 1460 may be direct or pass through a core network (like the core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by the UE 1406 and executable by the UE's processing circuitry. The software includes a client application, such as a web browser or operator-specific “app” that may be operable to provide a service to a human or non-human user via the UE 1406 with the support of the host 1402. In the host 1402, an executing host application may communicate with the executing client application via the OTT connection 1450 terminating at the UE 1406 and the host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via the connection 1460 between the host 1402 and the network node 1404 and via a wireless connection 1470 between the network node 1404 and the UE 1406 to provide the connection between the host 1402 and the UE 1406. The connection 1460 and the wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404 in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR, or AR which it can broadcast, multicast, or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1450 between the host 1402 and the UE 1406 in response to variations in the measurement results. The measurement procedure and/or the network functionality for reconfiguring the OTT connection 1450 may be implemented in software and hardware of the host 1402 and/or the UE 1406. In some embodiments, sensors (not shown) may be deployed in or in association with other devices through which the OTT connection 1450 passes; the sensors may participate in the measurement procedure by supplying values of the monitored quantities exemplified above, or by supplying values of other physical quantities from which software may compute or estimate the monitored quantities. The reconfiguring of the OTT connection 1450 may include message format, retransmission settings, preferred routing, etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency, and the like by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some exemplary embodiments of the present disclosure are as follows:

### Group A Embodiments

Embodiment 1: A method performed by a User Equipment, UE, (802), the method comprising: receiving (804), from a network node (800), information that configures the UE (802) with N_{TRP} Non-Zero Power, NZP, Channel State Information Reference Signal, CSI-RS, resources each with 2N₁N₂ CSI-RS antenna ports, for Coherent Joint Transmission, CJT, Channel State Information, CSI, feedback, wherein the CSI comprises information about a number of layers and for each of the NZP CSI-RS resources and each layer, information for one or more selected spatial domain, SD, basis vectors each representing a spatial beam, one or more selected frequency domain, FD, basis vectors, and a set of normalized coefficients each associated to one pair of the one or more SD and FD basis vectors and each antenna polarization; and receiving (806), from the network node (800), information that configures the UE (802) with amplitude restrictions for a subset of spatial vectors or beams associated to each of the N_{TRP} NZP CSI-RS resources.

Embodiment 2: The method of embodiment 1 wherein the amplitude restrictions comprise hard restrictions and/or soft restrictions, where a beam's amplitude is not allowed to exceed a threshold and in case of hard restrictions, the threshold is either one (i.e., without restriction) or zero (i.e., the beam is prohibited) and in case of soft restrictions, the threshold can be between zero and one.

Embodiment 3: The method of embodiment 1 or 2, wherein the amplitude of a beam at each layer is one of: (a) average amplitude over the selected FD basis vectors of the coefficients associated to the beam and the layer at one polarization; (b) amplitude corresponding to a normalized total power of the coefficients associated to the beam and the layer at one polarization with respect to a maximum total power of coefficients associated to all selected beams and the layer at one polarization per NZP CSI-RS resource among all the NZP CSI-RS resources; (c) amplitude corresponding to a normalized total power of the coefficients associated to the beam and the layer with respect to a maximum total power of coefficients associated to all selected beams and the layer per NZP CSI-RS resource among all the NZP CSI-RS resources.

Embodiment 4: The method of any of embodiments 1 to 3 wherein a restriction type of the amplitude restrictions is the same for all of the N_{TRP} NZP CSI-RS resources.

Embodiment 5: The method of any of embodiments 1 to 3 wherein a restriction type of the amplitude restrictions is different for different ones of the N_{TRP} NZP CSI-RS resources.

Embodiment 6: The method of any of embodiments 1 to 5 wherein the information that configures the UE (802) with amplitude restrictions for a subset of beams associated to each of the N_{TRP} NZP CSI-RS resources comprises a bit string,

$${B}_{G}^{( n )} {B}_{1}^{( n )} {B}_{2}^{( n )} {B}_{3}^{( n )} {B}_{4}^{( n )} ,$$

for the nth NZP CSI-RS resource, where

$${B}_{G}^{( n )}$$

identifies four beam groups and

$${B}_{k}^{( n )}$$

indicates thresholds for beams in the kth (k∈(0, 1, 2, 3)) identified beam group.

Embodiment 7: The method of embodiment 6, wherein there is one bit per beam in case of hard restriction and two bits per beam in case of soft restriction.

Embodiment 8: The method of any of embodiments 1 to 5 wherein the information that configures the UE (802) with amplitude restrictions for a subset of beams associated to each of the N_{TRP} NZP CSI-RS resources comprises a concatenation of bit strings for all of the N_{TRP} NZP CSI-RS resources comprising, for each nth NZP CSI-RS resource,

$${B}_{G}^{( n )} {B}_{1}^{( n )} {B}_{2}^{( n )} {B}_{3}^{( n )} {B}_{4}^{( n )} ,$$

where

$${B}_{G}^{( n )}$$

identifies four beam groups for the nth NZP CSI-RS resource and

$${B}_{k}^{( n )}$$

indicates thresholds for beams in the kth (k∈(0, 1, 2, 3)) identified beam group for the nth NZP CSI-RS resource.

Embodiment 9: The method of any of embodiments 1 to 8 wherein receiving (806) the information that configures the UE (802) with amplitude restrictions for a subset of beams associated to each of the N_{TRP} NZP CSI-RS resources comprises receiving (806) the information that configures the UE (802) with amplitude restrictions for a subset of beams associated to each of the N_{TRP} NZP CSI-RS resources via Radio Resource Control, RRC, signaling.

Embodiment 10: The method of any of embodiments 1 to 9 further comprising reporting (808) CJT CSI by selecting a set of beams across the N_{TRP} NZP CSI-RS resources and according to the received information on amplitude restrictions for a subset of beams.

Embodiment 11: The method of any of the previous embodiments, further comprising: providing user data; and forwarding the user data to a host via the transmission to the network node.

### Group B Embodiments

Embodiment 12: A method performed by a network node (800), the method comprising: sending (804), to a User Equipment, UE, (802), information that configures the UE (802) with N_{TRP} Non-Zero Power, NZP, Channel State Information Reference Signal, CSI-RS, resources each with 2N₁N₂ CSI-RS antenna ports, for Coherent Joint Transmission, CJT, Channel State Information, CSI, feedback, wherein the CSI comprises information about a number of layers and for each of the NZP CSI-RS resources and each layer, information for one or more selected spatial domain, SD, basis vectors each representing a spatial beam, one or more selected frequency domain, FD, basis vectors, and a set of normalized coefficients each associated to one pair of the one or more SD and FD basis vectors and each antenna polarization; and sending (806), to the UE (802), information that configures the UE (802) with amplitude restrictions for a subset of spatial vectors or beams associated to each of the N_{TRP} NZP CSI-RS resources.

Embodiment 13: The method of embodiment 12 wherein the amplitude restrictions comprise hard restrictions and/or soft restrictions, where a beam's amplitude is not allowed to exceed a threshold and in case of hard restrictions, the threshold is either one (i.e., without restriction) or zero (i.e., the beam is prohibited) and in case of soft restrictions, the threshold can be between zero and one.

Embodiment 14: The method of embodiment 12 or 13, wherein the amplitude of a beam at each layer is one of: (a) average amplitude over the selected FD basis vectors of the coefficients associated to the beam and the layer at one polarization; (b) amplitude corresponding to a normalized total power of the coefficients associated to the beam and the layer at one polarization with respect to a maximum total power of coefficients associated to all selected beams and the layer at one polarization per NZP CSI-RS resource among all the NZP CSI-RS resources; (c) amplitude corresponding to a normalized total power of the coefficients associated to the beam and the layer with respect to a maximum total power of coefficients associated to all selected beams and the layer per NZP CSI-RS resource among all the NZP CSI-RS resources.

Embodiment 15: The method of any of embodiments 12 to 14 wherein a restriction type of the amplitude restrictions is the same for all of the N_{TRP} NZP CSI-RS resources.

Embodiment 16: The method of any of embodiments 12 to 14 wherein a restriction type of the amplitude restrictions is different for different ones of the N_{TRP} NZP CSI-RS resources.

Embodiment 17: The method of any of embodiments 12 to 16 wherein the information that configures the UE (802) with amplitude restrictions for a subset of beams associated to each of the N_{TRP} NZP CSI-RS resources comprises a bit string,

$${B}_{G}^{( n )} {B}_{1}^{( n )} {B}_{2}^{( n )} {B}_{3}^{( n )} {B}_{4}^{( n )} ,$$

for the nth NZP CSI-RS resource, where

$${B}_{G}^{( n )}$$

identifies four beam groups and Bₖ⁽ⁿ⁾ indicates thresholds for beams in the kth (k∈(0, 1, 2, 3)) identified beam group.

Embodiment 18: The method of embodiment 17, wherein there is one bit per beam in case of hard restriction and two bits per beam in case of soft restriction.

Embodiment 19: The method of any of embodiments 12 to 16 wherein the information that configures the UE (802) with amplitude restrictions for a subset of beams associated to each of the N_{TRP} NZP CSI-RS resources comprises a concatenation of bit strings for all of the N_{TRP} NZP CSI-RS resources comprising, for each nth NZP CSI-RS resource,

$${B}_{G}^{( n )} {B}_{1}^{( n )} {B}_{2}^{( n )} {B}_{3}^{( n )} {B}_{4}^{( n )} ,$$

where

$${B}_{G}^{( n )}$$

identifies four beam groups for the nth NZP CSI-RS resource and Bₖ⁽ⁿ⁾ indicates thresholds for beams in the kth (k∈(0, 1, 2, 3)) identified beam group for the nth NZP CSI-RS resource.

Embodiment 20: The method of any of embodiments 12 to 19 wherein sending (806) the information that configures the UE (802) with amplitude restrictions for a subset of beams associated to each of the N_{TRP} NZP CSI-RS resources comprises sending (806) the information that configures the UE (802) with amplitude restrictions for a subset of beams associated to each of the N_{TRP} NZP CSI-RS resources via Radio Resource Control, RRC, signaling.

Embodiment 21: The method of any of the previous embodiments, further comprising: obtaining user data; and forwarding the user data to a host or a user equipment.

### Group C Embodiments

Embodiment 22: A user equipment comprising: processing circuitry configured to perform any of the steps of any of the Group A embodiments; and power supply circuitry configured to supply power to the processing circuitry.

Embodiment 23: A network node comprising: processing circuitry configured to perform any of the steps of any of the Group B embodiments; and power supply circuitry configured to supply power to the processing circuitry.

Embodiment 24: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 25: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 26: The host of the previous embodiment, wherein the cellular network further includes a network node configured to communicate with the UE to transmit the user data to the UE from the host.

Embodiment 27: The host of the previous 2 embodiments, wherein: the processing circuitry of the host is configured to execute a host application, thereby providing the user data; and the host application is configured to interact with a client application executing on the UE, the client application being associated with the host application.

Embodiment 28: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 29: The method of the previous embodiment, further comprising, at the host, executing a host application associated with a client application executing on the UE to receive the user data from the UE.

Embodiment 30: The method of the previous embodiment, further comprising: at the host, transmitting input data to the client application executing on the UE, the input data being provided by executing the host application, wherein the user data is provided by the client application in response to the input data from the host application.

Embodiment 31: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 32: The host of the previous embodiment, wherein the cellular network further includes a network node configured to communicate with the UE to transmit the user data from the UE to the host.

Embodiment 33: The host of the previous 2 embodiments, wherein: the processing circuitry of the host is configured to execute a host application, thereby providing the user data; and the host application is configured to interact with a client application executing on the UE, the client application being associated with the host application.

Embodiment 34: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 35: The method of the previous embodiment, further comprising: at the host, executing a host application associated with a client application executing on the UE to receive the user data from the UE.

Embodiment 36: The method of the previous embodiment, further comprising: at the host, transmitting input data to the client application executing on the UE, the input data being provided by executing the host application, wherein the user data is provided by the client application in response to the input data from the host application.

Embodiment 37: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 38: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 39: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 40: The method of the previous embodiment, further comprising, at the network node, transmitting the user data provided by the host for the UE.

Embodiment 41: The method of any of the previous 2 embodiments, wherein the user data is provided at the host by executing a host application that interacts with a client application executing on the UE, the client application being associated with the host application.

Embodiment 42: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 43: The communication system of the previous embodiment, further comprising: the network node; and/or the user equipment.

Embodiment 44: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 45: The host of the previous 2 embodiments, wherein: the processing circuitry of the host is configured to execute a host application, thereby providing the user data; and the host application is configured to interact with a client application executing on the UE, the client application being associated with the host application.

Embodiment 46: The host of the any of the previous 2 embodiments, wherein the initiating receipt of the user data comprises requesting the user data.

Embodiment 47: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 48: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, configuration information that configures the UE with a plurality of Non-Zero Power (NZP) Channel State Information Reference Signal (CSI-RS) resources each with 2N₁N₂ CSI-RS antenna ports, for Coherent Joint Transmission (CJT) Channel State Information (CSI) feedback, wherein N₁ and N₂ are positive integers;
receiving, from the network node, codebook subset restriction (CBSR) information for one or more of the plurality of NZP CSI-RS resources that configures the UE with amplitude restrictions for a subset of spatial vectors or beams on a per NZP CSI-RS resource basis; and
reporting, to the network node, CSI based on the configuration information and the CBSR information, wherein the CSI comprises:
information about a number of layers and a subset of the plurality of NZP CSI-RS resources; and
for each of the subset of the plurality of NZP CSI-RS resources, information for one or more selected spatial domain (SD) basis vectors or beams; and
for each of the number of layers, one or more selected frequency domain (FD) basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

2. The method of claim 1, wherein the amplitude restrictions are hard restrictions, wherein a spatial vector or beam is either allowed or prohibited in a CSI report in case of a hard restriction.

3. The method of claim 1, wherein, for each beam or spatial vector in the subset of spatial vectors or beams for which amplitude restrictions are configured to the UE for each of the one or more of the plurality of NZP CSI-RS resources, the CBSR information that configures the UE with the amplitude restrictions indicates whether there is no amplitude restriction for the beam or spatial vector or that the beam or spatial vector is prohibited.

4. (canceled)

5. (canceled)

6. The method of claim 1, wherein the CBSR information that configures the UE with amplitude restrictions for the subset of beams associated to each of the one or more of the plurality of NZP CSI-RS resources comprises a bit string,
$${B}_{G}^{( n )} {B}_{1}^{( n )} {B}_{2}^{( n )} {B}_{3}^{( n )} {B}_{4}^{( n )} ,$$
for the nth NZP CSI-RS resource, where
$${B}_{G}^{( n )}$$
identifies four beam groups and
$${B}_{k}^{( n )}$$
indicates amplitude restrictions for beams in the kth (k∈(0, 1, 2, 3)) identified beam group.

7. (canceled)

8. The method of claim 1, wherein the CBSR information that configures the UE with amplitude restrictions for the subset of beams associated to each of the one or more of the plurality of NZP CSI-RS resources comprises a concatenation of bit strings for all of the one or more of the plurality of NZP CSI-RS resources comprising, for each nth NZP CSI-RS resource,
$${B}_{G}^{( n )} {B}_{1}^{( n )} {B}_{2}^{( n )} {B}_{3}^{( n )} {B}_{4}^{( n )} ,$$
where
$${B}_{G}^{( n )}$$
identifies four beam groups for the nth NZP CSI-RS resource and Bₖ⁽ⁿ⁾ indicates amplitude restrictions for beams in the kth (k∈(0, 1, 2, 3)) identified beam group for the nth NZP CSI-RS resource.

9. (canceled)

10. The method of claim 1, wherein the amplitude restrictions comprise hard restrictions and/or soft restrictions, where a beam's amplitude is not allowed to exceed a threshold and in case of hard restrictions, the threshold is either one (i.e., without restriction) or zero (i.e., the beam is prohibited) and in case of soft restrictions, the threshold can be between zero and one.

11.-18. (canceled)

19. A User Equipment (UE), comprising:
a communication interface comprising a transmitter and a receiver; and
processing circuitry associated with the communication interface, the processing circuitry configured to cause the UE to:
receive, from a network node, configuration information that configures the UE with a plurality of Non-Zero Power (NZP) Channel State Information Reference Signal (CSI-RS) resources each with 2N₁N₂ CSI-RS antenna ports, for Coherent Joint Transmission (CJT) Channel State Information (CSI) feedback, wherein N₁ and N₂ are positive integers;
receive, from the network node, codebook subset restriction (CBSR) information for one or more of the plurality of NZP CSI-RS resources that configures the UE with amplitude restrictions for a subset of spatial vectors or beams on a per NZP CSI-RS resource basis; and
report, to the network node, CSI based on the configuration information and the CBSR information, wherein the CSI comprises:
information about a number of layers and a subset of the plurality of NZP CSI-RS resources; and
for each of the subset of the plurality of NZP CSI-RS resources, information for one or more selected spatial domain (SD) basis vectors or beams; and
for each of the number of layers, one or more selected frequency domain (FD) basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

20. The UE of claim 19, wherein the amplitude restrictions are hard restrictions, wherein a spatial vector or beam is either allowed or prohibited in a CSI report in case of a hard restriction.

21.-27. (canceled)

28. A method performed by a network node, the method comprising:
sending, to a User Equipment (UE) configuration information that configures the UE with a plurality of Non-Zero Power (NZP) Channel State Information Reference Signal (CSI-RS) resources each with 2N₁N₂ CSI-RS antenna ports, for Coherent Joint Transmission (CJT) Channel State Information (CSI) feedback, wherein N₁ and N₂ are positive integers;
sending, to the UE, codebook subset restriction (CBSR) information for one or more of the plurality of NZP CSI-RS resources that configures the UE with amplitude restrictions for a subset of spatial vectors or beams on a per NZP CSI-RS resource basis; and
receiving, from the UE, CSI based on the configuration information and the CBSR information, wherein the CSI comprises:
information about a number of layers and a subset of the plurality of NZP CSI-RS resources; and
for each of the subset of the plurality of NZP CSI-RS resources, information for one or more selected spatial domain (SD) basis vectors or beams; and
for each of the number of layers, one or more selected frequency domain (FD) basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

29. The method of claim 28, wherein the amplitude restrictions are hard restrictions, wherein a spatial vector or beam is either allowed or prohibited in a CSI report in case of a hard restriction.

30. The method of claim 28, wherein, for each beam or spatial vector in the subset of spatial vectors or beams for which amplitude restrictions are configured to the UE for each of the one or more of the plurality of NZP CSI-RS resources, the CBSR information that configures the UE with the amplitude restrictions indicates whether there is no amplitude restriction for the beam or spatial vector or that the beam or spatial vector is prohibited.

31. (canceled)

32. (canceled)

33. The method of claim 28, wherein the CBSR information that configures the UE with amplitude restrictions for the subset of beams associated to each of the one or more of the plurality of NZP CSI-RS resources comprises a bit string,
$${B}_{G}^{( n )} {B}_{1}^{( n )} {B}_{2}^{( n )} {B}_{3}^{( n )} {B}_{4}^{( n )} ,$$
for the nth NZP CSI-RS resource, where
$${B}_{G}^{( n )}$$
identifies four beam groups and
$${B}_{k}^{( n )}$$
indicates amplitude restrictions for beams in the kth (k∈(0, 1, 2, 3)) identified beam group.

34. (canceled)

35. The method of claim 28, wherein the CBSR information that configures the UE with amplitude restrictions for the subset of beams associated to each of the one or more of the plurality of NZP CSI-RS resources comprises a concatenation of bit strings for all of the one or more of the plurality of NZP CSI-RS resources comprising, for each nth NZP CSI-RS resource,
$${B}_{G}^{( n )} {B}_{1}^{( n )} {B}_{2}^{( n )} {B}_{3}^{( n )} {B}_{4}^{( n )} ,$$
where
$${B}_{G}^{( n )}$$
identifies four beam groups for the nth NZP CSI-RS resource and
$${B}_{k}^{( n )}$$
indicates amplitude restrictions for beams in the kth (k∈(0, 1, 2, 3)) identified beam group for the nth NZP CSI-RS resource.

36. (canceled)

37. The method of claim 28, wherein the amplitude restrictions comprise hard restrictions and/or soft restrictions, where a beam's amplitude is not allowed to exceed a threshold and in case of hard restrictions, the threshold is either one (i.e., without restriction) or zero (i.e., the beam is prohibited) and in case of soft restrictions, the threshold can be between zero and one.

38.-45. (canceled)

46. A network node comprising:
a communication interface; and
processing circuitry associated with the communication interface, the processing circuitry configured to cause the network node to:
send, to a User Equipment (UE) configuration information that configures the UE with a plurality of Non-Zero Power (NZP) Channel State Information Reference Signal (CSI-RS) resources each with 2N₁N₂ CSI-RS antenna ports, for Coherent Joint Transmission (CJT) Channel State Information (CSI) feedback, wherein N₁ and N₂ are positive integers;
send, to the UE, codebook subset restriction (CBSR) information for one or more of the plurality of NZP CSI-RS resources that configures the UE with amplitude restrictions for a subset of spatial vectors or beams on a per NZP CSI-RS resource basis; and
receive, from the UE, CSI based on the configuration information and the CBSR information, wherein the CSI comprises:
information about a number of layers and a subset of the plurality of NZP CSI-RS resources; and
for each of the subset of the plurality of NZP CSI-RS resources, information for one or more selected spatial domain (SD) basis vectors or beams; and
for each of the number of layers, one or more selected frequency domain (FD) basis vectors, and a set of normalized coefficients each associated to one of the one or more selected SD basis vectors or beams and one of the one or more selected FD basis vectors or beams for each antenna polarization, wherein the one or more selected SD basis vectors or beams are either unrestricted beams or satisfy the amplitude restrictions.

47. The network node of claim 46, wherein the amplitude restrictions are hard restrictions, wherein a spatial vector or beam is either allowed or prohibited in a CSI report in case of a hard restriction.

48.-54. (canceled)
